(19) United States
(12) Patent Application Publication
(10) Pub. No.: US 2023/0337029 A1
(43) Pub. Date: Oct. 19, 2023

(54) METHODS AND APPARATUSES FOR MEASUREMENT IN A WIRELESS COMMUNICATION SYSTEM

(71) Applicant: HUAWEI TECHNOLOGIES CO., LTD., SHENZHEN (CN)

(72) Inventors: HAO TANG, Shenzhen (CN); JIANGLEI MA, Kanata (CA); XIAOYAN BI, Shenzhen (CN); PEIYING ZHU, Kanata (CA)

(21) Appl. No.: 18/337,520

(22) Filed: Jun. 20, 2023

Related U.S. Application Data
(63) Continuation of application No. PCT/CN2020/138858, filed on Dec. 24, 2020.

(51) Int. Cl. H04W 24/08; H04W 24/10

(52) U.S. Cl. CPC H04W 24/08; H04W 24/10

(57) ABSTRACT

Methods and apparatuses for measurement in a wireless communication system are provided. In some embodiments, an apparatus transmits a measurement report for one carrier and/or bandwidth part (BWP) that is based on measurement information for another carrier and/or BWP. Further, the apparatus may switch between different carriers and/or BWPs to obtain measurement information in advance of scheduling transmissions on those different carriers and/or BWPs. Potential advantages include a reduction in measurement overhead at the apparatus.

### CROSS REFERENCE

This application is a continuation of International Application No. PCT/CN2020/138858, filed on Dec. 24, 2020, the disclosure of which is hereby incorporated by reference in its entirety.

### FIELD

The present disclosure generally relates to wireless communication and, in particular embodiments, to methods and apparatuses for measurement in a wireless communication system.

### BACKGROUND

An air interface is the wireless communications link between two or more communicating devices, such as a base station (also commonly referred to as an evolved NodeB, NodeB, NR base station, a transmit point, a remote radio head, a communications controller, a controller, and the like) and a user equipment (UE) (also commonly referred to as a mobile station, a subscriber, a user, a terminal, a phone, and the like).

A wireless communication from a UE to a base station is referred to as an uplink communication. A wireless communication from a base station to a UE is referred to as a downlink communication. Resources are required to perform uplink and downlink communications. For example, a base station may wirelessly transmit data to a UE in a downlink communication at a particular frequency for a particular duration of time. The frequency and time duration are examples of resources, typically referred to as “time-frequency resources”.

Two devices that wirelessly communicate with each other over time-frequency resources need not necessarily be a UE and a base station. For example, two UEs may wirelessly communicate with each other over a sidelink using device-to-device (D2D) communication. As another example, two network devices (for example, a terrestrial base station and a non-terrestrial base station, such as a drone) may wirelessly communicate with each other over a backhaul link.

When devices wirelessly communicate with each other, the wireless communication may be performed over a spectrum of frequencies occupying a bandwidth. A wireless communication may be transmitted on a carrier frequency. A carrier frequency will be referred to as a carrier. Different mechanisms are currently available in long-term evolution (LTE) and/or new radio (NR) to try to increase the bandwidth for the wireless communication, e.g. to allow for more throughput. As one example, carrier aggregation (CA) may be implemented in which multiple carriers are assigned to the same UE. Time-frequency resources may be allocated for communicating on any of the carriers. As another example, dual connectivity (DC) may be implemented. The UE may simultaneously transmit and receive data on multiple carriers from two cell groups via a master base station and a secondary base station, where the cell group corresponding to the master base station is called a master cell group (MCG), and the cell group corresponding to the secondary base station is called a secondary cell group (SCG).

Measurements are an important procedure in managing an air interface. Measurements may provide an indication of the quality of a wireless link between a UE and a base station, allowing the parameters of the air interface to be configured accordingly. However, the overhead associated with measurements is non-negligible.

### SUMMARY

The present disclosure relates, in part, to reducing measurement overhead in a wireless communication system. Measurement gaps are an example of measurement overhead. In some cases, a UE may require the use of a measurement gap to perform a measurement. During a measurement gap, data transmission to and/or from the UE may be interrupted. This interruption may lead to performance loss, such as a loss in data throughput, for example. The scheduling latency caused by performing measurements on a frequency resource may also contribute to measurement overhead. As such, a need exists for methods and apparatuses to reduce measurement overhead in a wireless communication system.

Some embodiments of the present disclosure implement measurement groups to reduce measurement overhead, for example, by reducing the utilization of measurement gaps. Measurement groups include multiple different carriers and/or bandwidth parts (BWPs) that are configured and/or active for an apparatus such as a UE, for example. One of the carriers/BWPs in a measurement group is a reference carrier/BWP that is physically measured to obtain measurement information. This measurement information is then used to obtain measurement reports for the other, non-reference carriers/BWPs in the measurement group. For example, the measurement information for non-reference carriers/BWPs may be predicted based on the measurement information for the reference carrier/BWP. In this way, measurements might not be performed on the non-reference carriers/BWPs in the measurement group, which may reduce the measurement overhead associated with the non-reference carriers/BWP. For example, the use of measurement gaps may be reduced.

Further, some embodiments of the present disclosure implement inter-carrier/BWP measurements, which may reduce measurement overhead by performing measurements on one or multiple configured carriers/BWPs during a single measurement period. These measurements may be performed in advance of using the configured carriers/BWPs for data transmission and/or reception, which may help achieve low latency scheduling on the configured carriers/BWPs.

According to an aspect of the present disclosure, there is provided a method for an apparatus (such as a UE, for example) in a wireless communication network. The apparatus is configured with a measurement group that includes a reference carrier/BWP and a non-reference carrier/BWP. The method includes receiving, from a network device such as a base station, a measurement configuration for the reference carrier/BWP. The method also includes measuring the reference carrier/BWP based on the measurement configuration to obtain measurement information for the reference carrier/BWP. The method further includes transmitting, to the network device, a measurement report for the non-reference BWP that is based on the measurement information for the reference carrier/BWP. In this way, the measurement report for the non-reference carrier/BWP may be transmitted without measuring the non-reference carrier/BWP. The measurement report may be obtained based on a measurement report configuration for the non-reference carrier/BWP received by the apparatus.

In some embodiments, the measurement group might be determined by the apparatus. For example, the method may include determining the measurement group and transmitting information regarding the measurement group to the network device. The information may include an indication of one or more preferred reference carriers/BWPs for the measurement group. The measurement group may be based on an artificial intelligence (AI) capability, a sensing capability or a position of the apparatus.

In some embodiments, the method further includes the apparatus determining measurement information for the non-reference carrier/BWP based on the measurement information for the reference carrier/BWP. The measurement report for the non-reference carrier/BWP may then be based on the measurement information for the non-reference carrier/BWP. Determining the measurement information for the non-reference carrier/BWP may be based on at least one of: position information, mobility information or sensing information for the apparatus.

According to another aspect of the present disclosure, there is provided a method for a network device such as a base station, for example, in a wireless communication system. The method includes transmitting, to an apparatus, a measurement configuration to obtain measurement information for a reference carrier/BWP in a measurement group. The method also includes receiving, from the apparatus, a measurement report for a non-reference carrier/BWP in the measurement group. The measurement report for the non-reference carrier/BWP is based on the measurement information for the reference carrier/BWP. In some embodiments, the measurement report may include measurement information for the reference carrier/BWP, and the method may further include the network device determining measurement information for the non-reference carrier/BWP based on the measurement information for the reference carrier/BWP.

In some embodiments, the network device configures the measurement group. The measurement group could be first determined by the apparatus, and then configured by the network device. Alternatively, the network device may determine the measurement group based on an artificial intelligence (AI) capability, a sensing capability and/or a position of the apparatus, for example. Optionally, the method may include the network device transmitting an indication of the configured measurement group to the apparatus.

In some embodiments, the network device may perform radio resource management (RRM) for the non-reference carrier/BWP based on the measurement report. For example, the method may include the network device transmitting an RRM instruction to the apparatus indicating at least one of: addition, modification, release, activation, deactivation, or scheduling of the non-reference carrier/BWP, or indicating, handover to or handover from the non-reference carrier/BWP.

According to yet another aspect of the present disclosure, there is provided an apparatus including at least one processor and a computer readable storage medium operatively coupled to the at least one processor, the computer readable storage medium storing programming for execution by the at least one processor. The programming includes instructions to receive, from a network device, a measurement configuration for a reference carrier/BWP of a measurement group. The programming also includes instructions to measure the reference carrier/BWP based on the measurement configuration to obtain measurement information for the reference carrier/BWP. The programming further includes instructions to transmit, to the network device, a measurement report for a non-reference carrier/BWP of the measurement group based on the measurement information for the reference carrier/BWP.

According to another aspect of the present disclosure, there is provided a network device including at least one processor and a computer readable storage medium operatively coupled to the at least one processor, the computer readable storage medium storing programming for execution by the at least one processor. The programming includes instructions to transmit, to an apparatus, a measurement configuration to obtain measurement information for a reference carrier/BWP of a measurement group. The programming also includes instructions to receive, from the apparatus, a measurement report for a non-reference carrier/BWP of the measurement group. The measurement report for the non-reference carrier/BWP is based on the measurement information for the reference carrier/BWP.

It should be noted that the methods described above are in no way limited to a single measurement group. Multiple measurement groups may be configured for an apparatus in some embodiments.

According to an aspect of the present disclosure, there is provided a method for an apparatus in a wireless communication network. The method includes receiving, from a network device, an indication to perform a configured measurement during a measurement period. The configured measurement includes a measurement of a first carrier/BWP during a first portion of the measurement period. Optionally, the configured measurement includes a measurement of a third carrier/BWP during a second portion of the measurement period. The method also includes switching, based on the received indication, from a second carrier/BWP to performing the measurement of the first carrier/BWP during the first portion of the measurement period. The method may further include switching from the first carrier/BWP to performing the measurement of the third carrier/BWP during the second portion of the measurement period. The switching may include radio frequency (RF) chain switching and/or antenna switching. The measurement information obtained for the first and/or third carriers/BWPs may be used to reduce latency when later scheduling transmissions on the first and/or third carriers/BWPs.

According to another aspect of the present disclosure, there is provided a method for a network device in a wireless communication network. The method includes determining, by the network device, a configured measurement including a measurement of a first carrier/BWP during a first portion of a measurement period and/or a measurement of a third carrier/BWP during a second portion of the measurement period. The method also includes transmitting, to an apparatus, an indication for the apparatus to switch from a second carrier/BWP to perform the measurement of the first carrier/BWP during the first portion of the measurement period. The indication may also indicate the apparatus to switch from the first carrier/BWP to perform the measurement of the third carrier/BWP during the second portion of the measurement period. The order of the first and the second portions of the measurement period may be preconfigured for the configured measurement. Alternatively, the method may further include the network device dynamically indicating the order for the first and second portions of the measurement period.

According to yet another aspect of the present disclosure, there is provided an apparatus including at least one processor and a computer readable storage medium operatively coupled to the at least one processor, the computer readable storage medium storing programming for execution by the at least one processor. The programming includes instructions to receive, from a network device, an indication to perform a configured measurement during a measurement period, the configured measurement including a measurement of a first carrier/BWP during a first portion of the measurement period. The programming also includes instructions to switch from a second carrier/BWP to performing the measurement of the first carrier/BWP during the first portion of the measurement period.

According to another aspect of the present disclosure, there is provided a network device including at least one processor and a computer readable storage medium operatively coupled to the at least one processor, the computer readable storage medium storing programming for execution by the at least one processor. The programming includes instructions to determine a configured measurement including a measurement of a first carrier/BWP during a first portion of a measurement period. The programming also includes instructions transmit, to an apparatus, an indication for the apparatus to switch from a second carrier/BWP to perform the measurement of the first carrier/BWP during the first portion of the measurement period.

### BRIEF DESCRIPTION OF THE DRAWINGS

Reference will now be made, by way of example, to the accompanying drawings which show example embodiments of the present application, and in which:

FIG. 1 is a schematic diagram of an example communication system suitable for implementing examples described herein;

FIG. 2 is a schematic diagram of another example communication system suitable for implementing examples described herein;

FIG. 3 is a block diagram illustrating example devices that may implement the methods and teachings according to this disclosure;

FIG. 4 is a block diagram illustrating example computing modules that may implement the methods and teachings according to this disclosure;

FIG. 5 illustrates four carriers on a frequency spectrum of a wireless medium;

FIG. 6 illustrates a single carrier having a single bandwidth part (BWP) consisting of two non-contiguous spectrum resources;

FIG. 7 illustrates a BWP on a frequency spectrum of a wireless medium;

FIG. 8 illustrates a single BWP having four non-contiguous spectrum resources;

FIG. 9 is a signaling diagram illustrating a UE-triggered intelligent measurement process, according to an embodiment;

FIG. 10 is a signaling diagram illustrating a base station-triggered intelligent measurement process, according to an embodiment;

FIG. 11 illustrates a time-frequency resource allocation including a configured inter-carrier/BWP measurement, according to an embodiment;

FIG. 12 to 15 are flow diagrams illustrating methods according to embodiments of the present disclosure.

### DESCRIPTION OF EXAMPLE EMBODIMENTS

To assist in understanding the present disclosure, examples of a wireless communication system is described below.

### Example Communication Systems and Devices

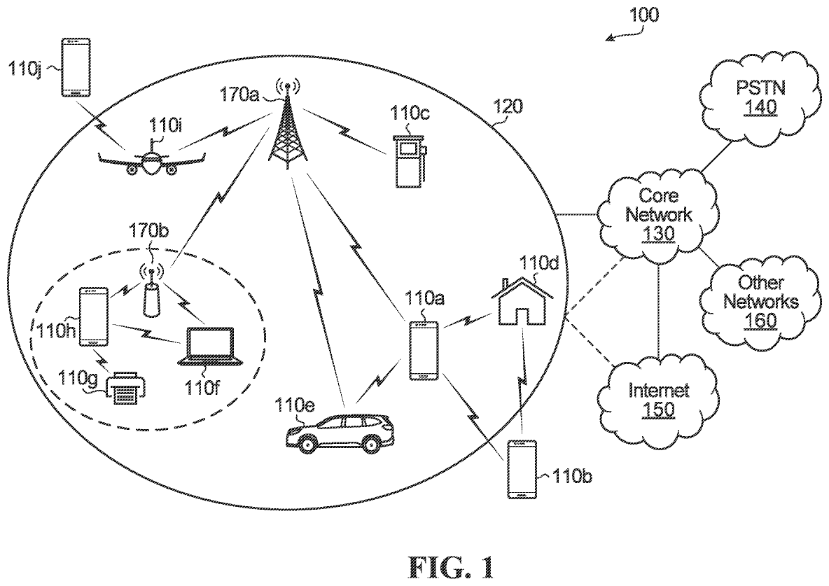

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

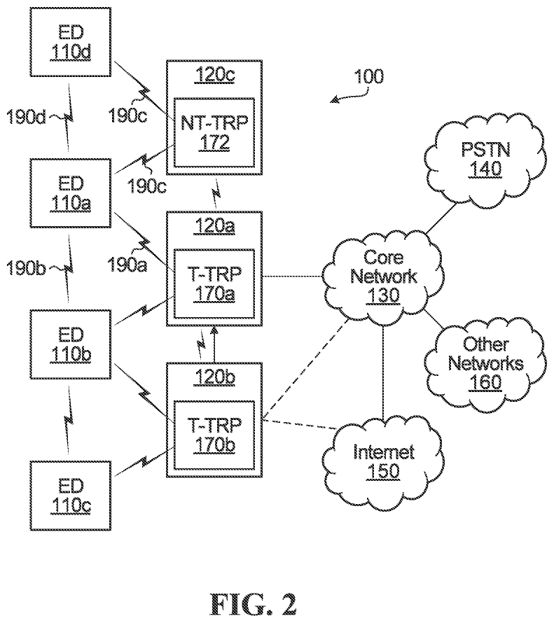

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. In some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

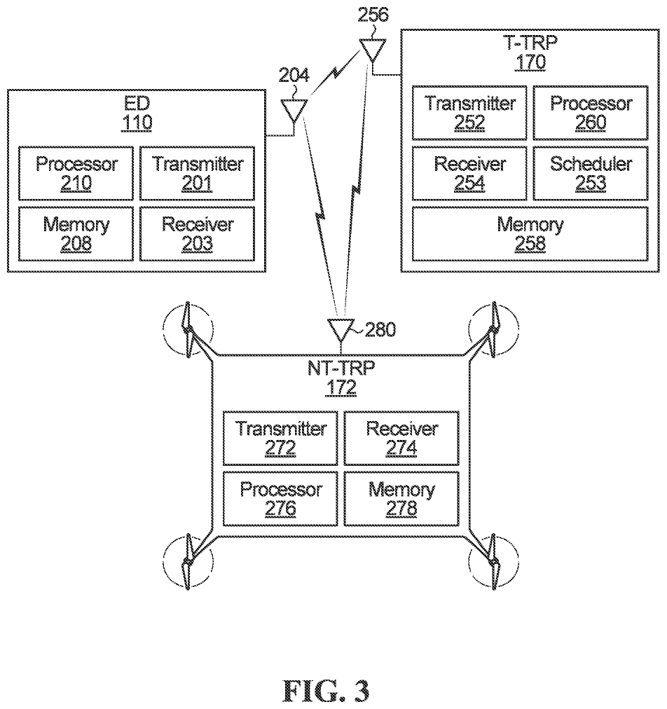

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

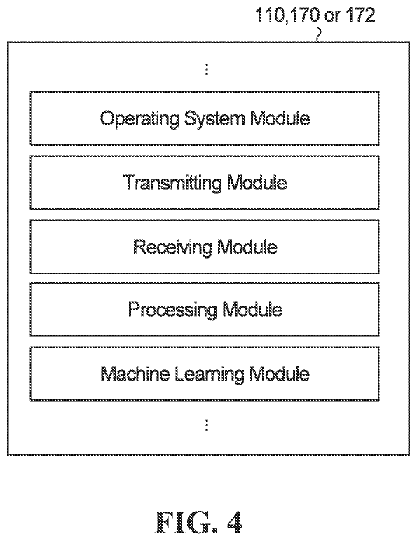

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Cells, Carriers, Bandwidth Parts (BWPs) and Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more BWPs. For example, a carrier may have one or more BWPs. More generally, wireless communication with the device may occur over a wireless spectrum. The spectrum may comprise one or more carriers and/or one or more BWPs. The spectrum may be referred to as frequency resources. Different carriers and/or BWPs may be on distinct frequency resources.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, e.g. sidelink transmitting and receiving resources.

A BWP may be broadly defined as a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

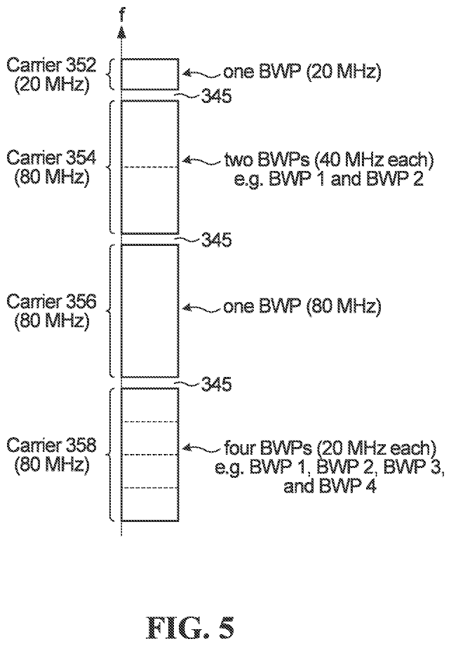

Therefore, in some embodiments, a carrier may have one or more BWPs. As an example, FIG. 5 illustrates four carriers on a frequency spectrum of a wireless medium. The four carriers are respectively labelled carriers 352, 354, 356, and 358. The four carriers are contiguous with each other, except that a guard band 345 may be interposed between adjacent pairs of contiguous carriers. Carrier 352 has a bandwidth of 20 MHz and consists of one BWP. Carrier 354 has a bandwidth of 80 MHz and consists of two adjacent contiguous BWPs, each BWP being 40 MHz, and respectively identified as BWP 1 and BWP 2. Carrier 356 has a bandwidth of 80 MHz and consists of one BWP. Carrier 358 has a bandwidth of 80 MHz and consists of four adjacent contiguous BWPs, each BWP being 20 MHz, and respectively identified as BWP 1, BWP 2, BWP 3, and BWP 4. Although not shown, a guard band may be interposed between adjacent BWPs.

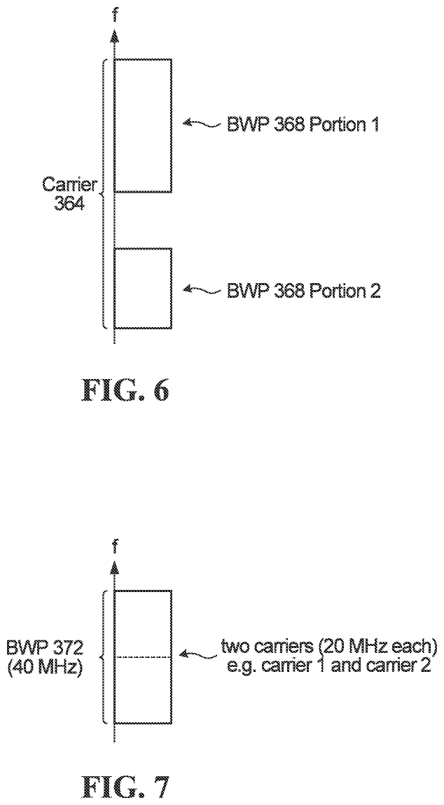

In some embodiments, a BWP has non-contiguous spectrum resources on one carrier. For example, FIG. 6 illustrates a single carrier 364 having a single BWP 368 consisting of two non-contiguous spectrum resources: BWP portion 1 and BWP portion 2.

In other embodiments, rather than a carrier having one or more BWPs, a BWP may have one or more carriers. For example, FIG. 7 illustrates a BWP 372 on a frequency spectrum of a wireless medium. BWP 372 has a bandwidth of 40 MHz and consists of two adjacent carriers, labelled carrier 1 and carrier 2, with each carrier having a bandwidth of 20 MHz. Carriers 1 and 2 are contiguous, except that a guard band (not shown) may be interposed between the carriers.

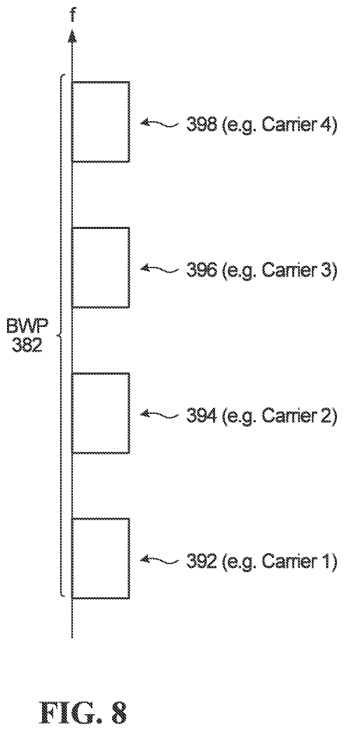

In some embodiments, a BWP may comprise non-contiguous spectrum resources which consists of non-contiguous multiple carriers. For example, FIG. 8 illustrates a single BWP 382 having four non-contiguous spectrum resources 392, 394, 396, and 398. Each non-contiguous spectrum resource consists of a single carrier. The first spectrum resource 392 is in a low band (e.g. the 2 GHz band) and consists of a first carrier (carrier 1). The second spectrum resource 394 is in a mmW band and consists of a second carrier (carrier 2). The third spectrum resource 396 (if it exists) is in the THz band and consists of a third carrier (carrier 3). The fourth spectrum resource 398 (if it exists) is in visible light band and consists of a fourth carrier (carrier 4). Resources in one carrier which belong to the BWP may be contiguous or non-contiguous. For example, the frequency resources of carrier 1 might be contiguous or non-contiguous.

Therefore, in view of the examples described in relation to FIGS. 5 to 8, it will be appreciated that a carrier may be a contiguous spectrum block for transmission and/or reception by device, such as a base station or a UE (e.g. like in FIG. 5), or a non-contiguous spectrum block for transmission and/or reception by a device (e.g. like in FIG. 6). A BWP may be a contiguous spectrum block for transmission and/or reception (e.g. like in FIGS. 5 and 8), or a contiguous spectrum block within a carrier (e.g. like in FIG. 5), or a non-contiguous spectrum block (e.g. like in FIGS. 6 and 8). A carrier may have one or more BWPs, or a BWP may have one or more carriers. A carrier or BWP may alternatively be referred to as spectrum.

As used herein, “carrier/BWP” refers to a carrier, or a BWP or both. For example, the sentence “the UE 110 sends a transmission on an uplink carrier/BWP” means that the UE 110 may send the transmission on an uplink carrier (that might or might not have one or more BWPs), or the UE may send the transmission on an uplink BWP (that might or might not have one or more carriers). The transmission might only be on a carrier, or might only be on a BWP, or might be on both a carrier and a BWP (e.g. on a BWP within a carrier).

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

In some embodiments, a carrier, a BWP and/or an occupied bandwidth may be signaled by a network device (e.g. a base station) dynamically (e.g. in physical layer control signaling such as downlink control information (DCI)), semi-statically (e.g. in radio resource control (RRC) signaling or in the medium access control (MAC) layer), or be predefined based on the application scenario. Alternatively or additionally, a carrier, a BWP and/or an occupied bandwidth may be determined by a UE as a function of other parameters that are known by the UE, or may be fixed, e.g. by a standard.

Control information is discussed herein in some embodiments. Control information may sometimes instead be referred to as control signaling, signaling, configuration information, or a configuration. An example of control information is information configuring different carriers/BWPs. In some cases, control information may be dynamically indicated to the UE, e.g. in the physical layer in a control channel. An example of control information that is dynamically indicated is information sent in physical layer control signaling, e.g. downlink control information (DCI). Control information may sometimes be semi-statically indicated, e.g. in RRC signaling or in a MAC control element (MAC CE). A dynamic indication may be an indication in a lower layer (e.g. physical layer or layer 1 signaling such as DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

In embodiments described herein, “adding” a carrier/BWP for a UE refers to indicating, to the UE, a carrier/BWP that may possibly be used for communication to and/or from the UE. Adding a carrier/BWP may alternatively be referred to as “assigning” the carrier/BWP or “configuring” the carrier/BWP. In some embodiments, adding the carrier/BWP for a UE may include indicating, to the UE, one or more parameters of the carrier/BWP, e.g. indicating the carrier/BWP frequency, the carrier/BWP bandwidth and/or the carrier/BWP index. In some embodiments, the carrier/BWP may be added to a carrier/BWP group that is associated with the UE.

“Activating” a carrier/BWP refers to indicating, to the UE, that the carrier/BWP is now available for use for communication to and/or from the UE. In some embodiments, a carrier/BWP is implicitly or explicitly activated at the same time the carrier/BWP is added for the UE. In other embodiments, a carrier/BWP may be added and then later activated using control signaling (e.g. using dynamic control signaling, such as DCI). Therefore, it is possible in some embodiments that a carrier/BWP be added for the UE but initially deactivated, i.e. not available for wireless communication for the UE, such that no transmissions are scheduled, sent or received by the UE on the carrier/BWP. The carrier/BWP may be subsequently activated, and then possibly deactivated again later.

“Removing” a carrier/BWP for a UE refers to indicating, to the UE, that the carrier/BWP is no longer available to be used for communication to and/or from the UE. The carrier/BWP may be removed from a carrier/BWP group associated with the UE. Removing a carrier/BWP may alternatively be referred to as “releasing” the carrier/BWP or “de-configuring” the carrier/BWP. In some embodiments, removing a carrier/BWP is the same as deactivating the carrier/BWP. In other embodiments, a carrier/BWP might be deactivated without being removed.

“Modifying” a carrier/BWP for a UE refers to updating/changing the configuration of a carrier/BWP for a UE, e.g. changing the carrier/BWP index, changing the bandwidth, changing the transmission direction and/or changing the function of the carrier/BWP, etc. In some embodiments, modifying the carrier/BWP does not change the activation status of the carrier/BWP, e.g. if the carrier/BWP is activated then it remains activated after the modification.

“Handover to” a particular carrier/BWP refers to a UE switching from communicating on one carrier/BWP to communicating on the particular carrier/BWP. Similarity, “handover from” a particular carrier/BWP refers to a UE switching from communicating on the particular carrier/BWP to communication on another carrier/BWP. A handover to/from a carrier/BWP may include adding, removing, modifying, activating or deactivating the carrier/BWP.

“Scheduling” a carrier/BWP for a UE refers to scheduling a transmission on the carrier/BWP. In some embodiments, the scheduling of a carrier/BWP may explicitly or implicitly add and/or activate the carrier/BWP for the UE if the carrier/BWP is not previously added and/or activated.

In general, carriers/BWPs may be added, removed, modified, scheduled, activated and/or deactivated for a UE via control signaling from the base station, e.g. dynamically in physical layer control signaling (such as in DCI) or semi-statically in higher-layer signaling (such as RRC signaling or in a MAC CE). Adding, removing, modifying, activating and/or deactivating a carrier/BWP may collectively be referred to as managing the carrier/BWP (e.g. RRM for the carrier/BWP). A handover to and/or a handover from a carrier/BWP may also be indicated for a UE via control signaling from the base station.

In some embodiments herein, a carrier/BWP is sometimes configured as an “uplink carrier/BWP” or a “downlink carrier/BWP”. An uplink carrier/BWP is a carrier or BWP that is configured for uplink transmission. A downlink carrier/BWP is a carrier or BWP that is configured for downlink transmission. In some embodiments, a carrier/BWP may switch from an uplink carrier/BWP to a downlink carrier/BWP, and/or vice versa, e.g. in response to control signaling received from the base station. The control signaling may be dynamic (e.g. physical layer control signaling, such as in DCI) or semi-static (e.g. in higher-layer signaling, such as RRC signaling or in a MAC CE).

In some embodiments, a UE uses radio frequency (RF) components to implement wireless communication over a carrier/BWP. Some RF components may instead be called analog components. Examples of RF components may include one or more of the following: antennas, and/or antenna arrays, and/or power amplifiers, and/or filters, and/or frequency up-convertors, and/or frequency down-convertors, and/or analog-to-digital convertors (ADCs), and/or digital-to-analog convertors (DACs). To implement a wireless communication, a set of RF components are arranged in a particular order to form an RF chain to transmit and/or receive the wireless communication. An RF chain may be a receive RF chain (i.e. an RF chain to receive a wireless communication) or a transmit RF chain (i.e. an RF chain to transmit a wireless communication). A particular group of RF components may be configured as a receive RF chain, a transmit RF chain, or both a receive and transmit RF chain, and a UE may possibly change the configuration.

A UE may switch an RF chain and/or an antenna (RF/antenna) between different carriers/BWPs, which may be referred as “RF/antenna switching” or “RF switching”. For example, a UE may have limited RFs/antennas and may therefore switch an RF/antenna from a first carrier/BWP to a second carrier/BWP in order to communicate over the second carrier/BWP. RF switching may include switching one or more radio components from one frequency to another frequency. For example, RF switching may include antenna switching, power amplifier (PA) switching and/or filter switching. In some cases, RF bandwidth might not be changed after RF switching.

Alternatively or additionally, a UE may implement RF bandwidth adaptation to communicate over a different carrier/BWP using a particular RF/antenna. RF bandwidth adaption includes adjusting the bandwidth of an RF/antenna, for example, from 20 MHz to 50 MHz. In some cases, RF bandwidth adaptation may be faster than RF switching.

It should be noted that while some embodiments of the present disclosure are described in relation to communications between a UE and a BS (for example, uplink and/or downlink transmissions), the present disclosure is in no way limited to such communications. The embodiments described herein may also or instead be implemented in sidelink, backhaul links and/or vehicle-to-everything (V2X) links, for example. Further, the embodiments described herein may apply to transmissions over licensed spectrum, unlicensed spectrum, terrestrial transmissions, non-terrestrial transmissions (for example, transmissions within non-terrestrial networks), and/or integrated terrestrial and non-terrestrial transmissions.

### Integrated Terrestrial Networks and Non-Terrestrial Networks

A terrestrial communication system may also be referred to as a land-based or ground-based communication system, although a terrestrial communication system can also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communication system using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like conventional Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

### Artificial Intelligence (AI) and Sensing

In some embodiments, devices such as the ED 110, the T-TRP 170 and/or the NT-TRP 172 of FIG. 3 implement sensing technologies and/or AI technologies. Sensing and/or AI may be introduced into a telecommunication system to improve performance and efficiency.

AI and/or machine learning (ML) technologies may be applied in the physical layer and/or in the MAC layer. For the physical layer, AI/ML may improve component design and/or algorithm performance, including but not limited to channel coding, channel modelling, channel estimation, channel decoding, modulation, demodulation, MIMO, waveform, multiple access, PHY element parameter optimization and update, beam forming & tracking, and sensing & positioning. For the MAC layer, AI/ML capabilities such as learning, prediction and decision making, for example, may be utilized to solve complicated problems. According to an example, AI/ML may be utilized to improve functionality in the MAC layer through intelligent TRP management, intelligent beam management, intelligent channel resource allocation, intelligent power control, intelligent spectrum utilization, intelligent MCS, intelligent HARQ strategy, and/or intelligent Tx/Rx mode adaption.

In some embodiments, AI/ML architectures involve multiple nodes. The multiple nodes may be organized into two modes, i.e., centralized and distributed, both of which can be deployed in an access network, a core network, or an edge computing system or third network. The implementation of a centralized training and computing architecture may be restricted by a large communication overhead and strict user data privacy. A distributed training and computing architecture, such as distributed machine learning and federated learning, for example, may include several frameworks. AI/ML architectures could include an intelligent controller which may perform as single agent or multi-agent, based on joint optimization or individual optimization. A protocol and signaling mechanism may provide a corresponding interface link that can be personalized with customized parameters to meet particular requirements while minimizing signaling overhead and maximizing the whole system spectrum efficiency through personalized AI technologies.

Through the use of sensing technologies, terrestrial and non-terrestrial networks can enable a new range of services and applications such as earth monitoring, remote sensing, passive sensing and positioning, navigation, tracking, autonomous delivery and mobility. Terrestrial network-based sensing and non-terrestrial network-based sensing could provide intelligent, context-aware networks to enhance the UE experience. For an example, terrestrial network-based sensing and non-terrestrial network-based sensing could provide opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods might not only enable advanced cross reality (XR) applications, but also enhance the navigation of autonomous objects such as vehicles and drones. Further, measured channel data and sensing and positioning data can be obtained through large bandwidth, new spectrum, dense networks and more line-of-sight (LOS) links. Based on measured channel data and sensing and positioning data, a radio environmental map may be drawn through AI/ML methods, where channel information is linked to its corresponding positioning or environmental information to provide an enhanced physical layer design based on this map.

Sensing coordinators are nodes in a network that can assist in the sensing operation. These nodes can be stand-alone nodes dedicated to sensing operations or other nodes (for example the T-TRP 170, ED 110, or core network node) that perform sensing operations in parallel with communication transmissions. Protocol and signaling mechanisms may provide a corresponding interface link with customized parameters to meet particular requirements while minimizing signaling overhead and maximizing spectrum efficiency.

AI/ML and sensing methods may be data-hungry. Therefore, in order to involve AI/ML and sensing in wireless communications, a large amount of data may be collected, stored, and exchanged. The characteristics of wireless data may expand in multiple dimensions, such as from sub-6 GHz, millimeter to Terahertz carrier frequencies, from outdoor to indoor environments, and from text, voice to video. The data collecting, processing and usage may be performed in a unified framework or another framework.

### Measurement

Measurement is an important procedure in many communication networks, including 4G and 5G networks, for example. Measurements may allow a network to determine the quality of a link between two devices, such as a UE and a BS. In some cases, measurements may be used to determine the quality of a link provided by a particular carrier/BWP, in order to determine whether the carrier/BWP should be added, removed, modified, scheduled, activated and/or deactivated, or if a handover should be performed to or from the carrier/BWP, for example.

To configure a measurement at a UE, a BS may provide a measurement configuration to the UE through control signaling. The measurement configuration may provide information that allows the UE to perform a measurement and send a measurement report back to the BS. The measurement report may then be used by the BS perform radio resource management (RRM), including but not limited to cell selection and reselection, handover, load balancing, and serving cell addition and/or removal.

In some embodiments, a particular carrier/BWP may be configured for measurement, which means that the carrier/BWP is configured for transmission of a signal that is used to measure the quality of the link provided by the carrier/BWP for RRM, for example. The measurement may be a channel measurement that is used to obtain information about the channel. In some embodiments, a measurement may be a downlink measurement (for example, to obtain information about a downlink channel), an uplink measurement (for example, to obtain information about an uplink channel), a beam measurement (for example, to obtain information about a particular transmission beam), a synchronization measurement (for example, to obtain synchronization information), and/or a timing advance measurement (for example, to obtain information about transmission timing).

According to one example, a downlink carrier/BWP (or at least a carrier/BWP having downlink resources) is used by a base station to transmit, to a UE, a reference signal or a synchronization signal. An example of a reference signal is a channel state information reference signal (CSI-RS). An example of a synchronization signal is a primary synchronization signal (PSS) and/or a secondary synchronization signal (SSS) in a synchronization signal block (SSB). The reference signal and/or synchronization signal is used by the UE to perform a measurement and thereby obtain measurement information. The reference signal and/or synchronization signal may be referred to as a measurement object.

In another example, an uplink carrier/BWP (or at least a carrier/BWP having uplink resources) is used by a UE to transmit a reference signal, for example, a sounding reference signal (SRS). The reference signal is used by a BS to perform a measurement and thereby obtain measurement information. The measurement information may be used by the BS to perform RRM. As an example, if the measurement information indicates that the uplink carrier/BWP is of too low quality, then the BS may deactivate the uplink carrier/BWP for the UE.

Measurement information that is obtained via a measurement may include any, one, some or all of the following types of measurement information: Reference Signal Received Power (RSRP); Reference Signal Received Quality (RSRQ); Signal-to-Noise Ratio (SNR); Signal-to-Noise and Interference Ratio (SINR); Received Signal Strength Indicator (RSSI); Cross Link Interference (CLI); Doppler shift; Doppler spread; average delay; delay spread; Channel Quality Information (CQ); Precoding Matrix Indicator (PMI); Channel State Information-Reference Signal (CSI-RS Resource Indicator (CRI); Synchronization Signal/Physical Broadcast Channel (SS/PBCH) Resource Block Indicator (SSBRI); Layer Indicator (LI); Rank Indicator (RI); Layer1 RSRP; Channel occupancy Ratio (Sidelink CR); and Channel Busy Ratio (Sidelink CBR). These types of measurement information, which may also be referred to as “measurement quantities”, “measurement items” or “measurement results”, are not intended to be limiting. Other types of measurement information are also contemplated.

Measurement information may include intra-frequency measurement results, inter-frequency measurement results and/or inter-radio access technology (RAT) measurement results. Intra-frequency measurement results may be obtained from measurements on a carrier/BWP that is active at a UE. Inter-frequency measurement results may be obtained from measurements on a carrier/BWP that is inactive at a UE. Inter-RAT measurement results may be obtained from measurements on a type of RAT that a UE is not communicating on. Intra-frequency measurement results, inter-frequency measurement results, and/or inter-RAT measurement results may be used to configure a handover, for example.

Measurement information may also be defined at different levels. For example, measurement information may include beam-level measurement results, BWP-level measurement results, carrier-level measurement results, and/or cell-level measurement results. Beam-level measurement results may be obtained from measurements on a particular beam. Similarly, BWP-level measurement results may be obtained from measurements on a particular BWP, carrier-level measurement results may be obtained from measurements on a particular carrier, and cell-level measurement results may be obtained from measurements on a particular cell.

Following a measurement performed by a UE, a measurement report may be transmitted from the UE to a BS. In some embodiments, the measurement report might be transmitted on the carrier/BWP configured for measurement, for example, in uplink resources on the same carrier/BWP on which a reference signal or synchronization signal was transmitted in the downlink. The measurement report may provide any, some or all of the measurement information obtained via a measurement. The measurement information may then be used by the base station to perform RRM. As an example, if the measurement information indicates that a downlink carrier/BWP is of too low quality, then the BS may deactivate the downlink carrier/BWP for the UE.

The overhead associated with measurements in a wireless communication network is non-negligible. One example of measurement overhead is a measurement gap, which is the time period during which a UE ceases data communication in order to perform a measurement. A measurement gap might be required when a UE cannot simultaneously transmit/receive data on one carrier (for example, a primary component carrier (PCC)) while performing a measurement on another carrier (for example, a secondary CC (SCC)). During a measurement gap, data transmission to/from the UE is interrupted, potentially leading to performance loss (for example, a loss in throughput). Measurements gaps might be required for intra-frequency, inter-frequency and/or inter-RAT measurements.

Measurement overhead may be problematic for a UE that is implementing CA and/or DC. During CA and DC, measurements may be performed for each configured carrier, which may require measurement gaps and induce a relatively large measurement overhead.

### Measurement Groups

An aspect of the present disclosure relates to reducing measurement overhead in a wireless communication network. In some embodiments, the measurement information for some carriers/BWPs is predicted by a UE and/or by a BS, rather than being measured. For example, the quality of a link provided by one carrier/BWP may be used to determine the quality of a link provided by another carrier/BWP. This may reduce the number of carriers/BWPs that are measured by a UE, thereby reducing measurement overhead for the UE by reducing the use of measurement gaps, for example. In this way, predicting measurement information provides a technical benefit over prior schemes where measurements are independently performed on each carrier/BWP (for example, in NR or LTE). Predicting the measurement information for a carrier/BWP may be considered a form of intelligent measurement.

Some embodiments of the present disclosure implement the concept of a measurement group (MG). A MG is a set of multiple carriers and/or multiple BWPs. At least one of the carriers/BWPs in a MG is a reference carrier/BWP, which is a carrier/BWP that is physically measured to obtain corresponding measurement information. The other carrier(s)/BWP(s) in the MG, which may be referred to as “non-reference carrier(s)/BWP(s)”, is/are not directly measured. Rather, measurement information for a non-reference carrier/BWP may be inferred, predicted or otherwise determined based on the measurement information obtained for the reference carrier/BWP. As such, measurement of the non-reference carrier/BWP is not performed by the UE, resulting in reduced measurement overhead.

According to one example, a MG includes multiple carriers. At least one of these carriers is a reference carrier in the MG, and the other carriers are non-reference carriers. Measurement information for the reference carrier is obtained through a configured measurement at a UE. The measurement information for the non-reference carriers may then be predicted by the UE or by a BS based on the measurement information for the reference carrier.

According to another example, a MG includes multiple BWPs. At least one of the BWPs is a reference BWP in the MG and the other BWPs are non-reference BWPs. Measurement information for the reference BWP is obtained through a measurement of the reference BWP, and the measurement information for the non-reference BWPs may then be predicted by a UE or by a BS.

The method by which a UE or a BS predicts measurement information for a non-reference carrier/BWP is not limited herein. In some embodiments, the measurement information obtained for a reference carrier/BWP in a MG is applied to a non-reference carrier/BWP in the MG. By way of example, if the RSRP of a reference carrier/BWP in a MG indicates that the reference carrier/BWP should be deactivated, then a BS may also deactivate one or more non-reference carriers/BWPs in the MG.

In other embodiments, measurement information for a non-reference carrier/BWP may be calculated from the measurement information for a reference carrier/BWP. One or more functions may be used to relate the measurement information of a reference carrier/BWP to the measurement information of a non-reference carrier/BWP. An example of such a function is: M_{NR}=(a*M_{R}+b)*c, where M_{NR} is a type of measurement information for a non-reference carrier/BWP, M_{R} is a type of measurement information for a reference carrier/BWP, and a, b and c are constants. After calculating the measurement information for a non-reference carrier/BWP using a function, the non-reference carrier/BWP may be managed (for example, activated or deactivated) by a BS accordingly.

In some embodiments, a particular type of measurement information for a non-reference carrier/BWP may be predicted based on the same type of measurement information for a reference carrier/BWP. By way of example, for a MG including 2 carriers (“CC1” and “CC2”) that are optionally in the same frequency band, a UE may predict the RSRP of CC1 based on the RSRP of CC2. In this example, CC1 is a non-reference carrier in the MG and CC2 is a reference carrier in the MG. Only the RSRP of CC2 needs to be measured, thereby potentially saving measurement overhead for CC1.

Alternatively or additionally, a particular type of measurement information for a non-reference carrier/BWP may be predicted based on one or more different types of measurement information for a reference carrier/BWP. Referring again to the MG including CC1 and CC2, a UE or a BS may predict RSRQ for CC1 based on a measured RSRP for CC2. Further, RSRQ for CC1 may be predicted based on both RSRP and RSRQ for CC2.

In some embodiments, AI/ML may be implemented to help calculate or otherwise predict the measurement information for a non-reference carrier/BWP. The predictive capabilities of AL/ML could be leveraged to relate measurement information for a reference carrier/BWP to measurement information for the non-reference carrier/BWP. For example, an ML model may be generated using a training data set including measurement information for a reference carrier/BWP and measurement information for a non-reference carrier/BWP. The ML model may then predict measurement information for the non-reference carrier/BWP using new measurement information for the reference carrier/BWP as an input. AI/ML may be implemented at a UE and/or at a BS.

Positioning information, mobility information and/or sensing information could be used to help predict measurement information for a non-reference carrier/BWP. Positioning information may indicate the location of a UE, including the longitude, latitude, altitude and/or orientation of the UE, for example. Mobility information may include the speed and/or direction that a UE is moving. Sensing information may provide an indication of the radio environment surrounding a UE, which may include a radio environmental map including scattering objects proximate the UE, for example. Positioning, mobility and/or sensing information may be obtained by a UE and/or by a BS.

The relationship between measurement information for a reference carrier/BWP and measurement information for a non-reference carrier/BWP may be dependent on the location, mobility and/or radio environment of a UE. According to one example, measurement information for a reference carrier/BWP may be substantially the same as measurement information for a non-reference carrier/BWP when a UE is at a cell center, but may have a more complex relationship when the UE is at a cell edge. As such, position information for the UE may be used to more accurately predict measurement information for the non-reference carrier/BWP.

According to another example, measurement information for a reference carrier/BWP may be substantially the same as measurement information for a non-reference carrier/BWP when a UE is stationary, but may have a more complex relationship when the UE is in motion. As such, mobility information for the UE may be used to more accurately predict measurement information for the non-reference carrier/BWP.

According to yet another example, a reference carrier/BWP and a non-reference carrier/BWP may correspond to different BSs, such as a master BS and a secondary BS, for example. Sensing information may indicate whether a scattering object is disposed between a UE and either of the BSs, which could affect the relationship between the measurement information for the reference carrier/BWP and measurement information for the non-reference carrier/BWP.

In some embodiments, an AI/ML model may use positioning information, mobility information and/or sensing information as inputs to predict measurement information.

In some embodiments, a MG group is UE-specific. The MG may have been configured for the UE, optionally based on the properties of the UE, and may be used to obtain measurement information for the UE. Other UEs may be configured with other MGs. In some embodiments, a MG for a UE may be configured based on a UE's AI/ML, positioning and/or sensing capabilities. If a UE has advanced AI/ML, positioning and/or sensing capabilities, then a MG for the UE may be defined to leverage these capabilities. For example, a UE with advanced AI/ML, positioning and/or sensing capabilities may be able to determine position, mobility and/or sensing information with a higher degree of accuracy, which may help enable the implementation of a MG with larger numbers of carriers/BWPs and/or with complex predictions of measurement information for non-reference carriers/BWPs.

In some embodiments, a MG may correspond to (i.e., be specific to) one or more types of measurement information. The MG may be used to obtain these types of measurement information for the carriers/BWPs in the MG, but might not be used to obtain other types of measurement information. One or more additional MGs may also be configured, where the additional MGs correspond to different types of measurement information. Stated differently, multiple MG groups corresponding to different types of measurement information may be configured for a UE. As an example, the following MGs may be configured for a UE:
a first MG (“MG-1”) for RSRP, RSRQ and SNR;
a second MG (“MG-2”) for SINR, RSSI and CLI;
a third MG (“MG-3”) for Doppler shift, Doppler spread, average delay and delay spread; and
a fourth MG (“MG-4”) for beam management, including PMI, CRI and SSBRI.

One carrier/BWP may belong to one MG or may belong to multiple MGs. In other words, all of the measurement information for a particular carrier/BWP may be determined from a single MG, or the measurement information for the carrier/BWP may be determined using a combination of multiple MGs.

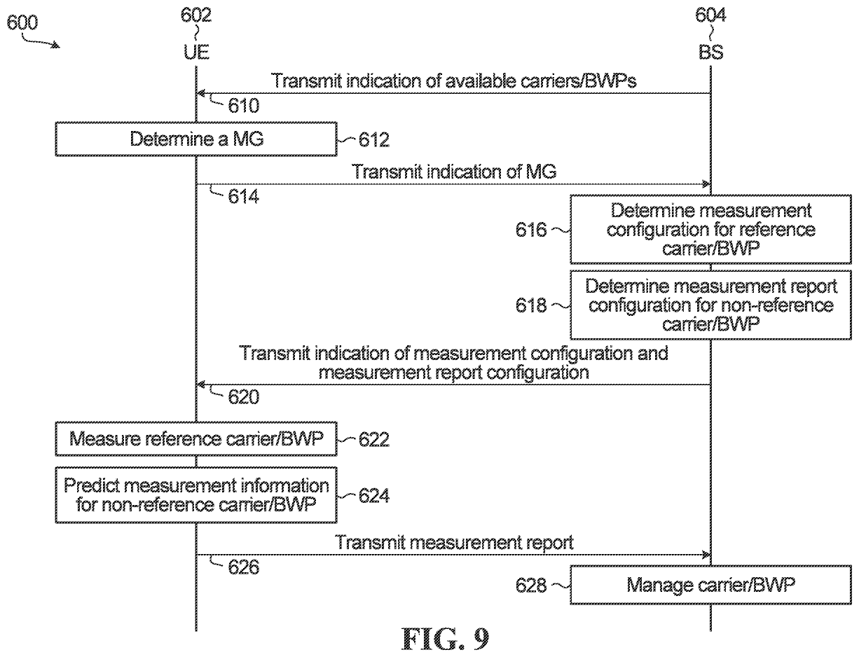

In some embodiments, a UE determines at least some of the measurement information for non-reference carriers/BWPs in a MG. The UE may also at least partially determine or configure the MG, or send an indication of a preferred MG configuration to a BS. This may be referred to as UE-triggered intelligent measurement or intelligent measurement prediction at the UE side. FIG. 9 is a signaling diagram illustrating a UE-triggered intelligent measurement process 600, according to an embodiment. The process 600 provides an example of a UE 602 determining a MG and predicting measurement information for non-reference carriers/BWPs in the MG. A BS 604 may then manage the non-reference carriers/BWPs based on the predicted measurement information.

In some implementations, CA may be implemented for communication between the UE 602 and the BS 604. Alternatively or additionally, the UE 602 may implement DC with a MCG and a SCG, where the BS 604 may be a master BS of the MCG or a secondary BS of the SCG.

In some implementations, the UE 602 may be similar to the UE 110 of FIG. 2 and/or the BS 604 may be similar to the BS 170 of FIG. 3. However, other implementations of the UE 602 and the BS 604 are also contemplated. The UE 602 might be one or more of the following: a smartphone; an Internet of Things (IoT) device; a wearable device; and a vehicular device (for example, a vehicle-mounted device, or vehicle on-board equipment).

Step 610 of the process 600 includes the BS 604 transmitting an indication of the available or configured carriers/BWPs for the UE 602. This indication may include the carrier/BWP frequency and bandwidth for each of the available or configured carriers/BWPs. The indication transmitted in step 610 may be transmitted through control signaling, such as RRC signaling, a MAC CE or DCI, for example.

Step 612 includes the UE 602 determining a MG group based on the available carriers/BWPs. The MG determined in step 612 may be considered a preferred MG for the UE 602. The UE 602 may determine the carriers/BWPs included in the MG, as well as the type(s) of measurement information that the MG corresponds to (i.e., the type(s) of measurement information that the MG is used to obtain). Optionally, the UE 602 may also select one or more preferred reference carriers/BWPs for the MG. As outlined above, step 612 may be performed based on an AI/ML capability of the UE 602, a positioning capability of the UE 602 and/or a sensing capability of the UE 602. Step 612 may also or instead be performed based on sensing information for the UE 602, position information for the UE 602, and/or mobility information for the UE 602.

In some implementations, the selection of the preferred reference carrier/BWP in step 612 may be based on the capabilities and/or preferences of the UE 602. By way of example, if the RF implementation of the UE 602 enables measurement of a particular carrier/BWP in the MG without using a measurement gap, then the UE 602 may select this carrier/BWP as the preferred reference carrier/BWP for the MG in order to avoid the use of a measurement gap and improve data throughput.

In some implementations, the UE 602 may determine multiple MGs in step 612. Each MG may include different carriers/BWPs and/or may correspond to one or more different type(s) of measurement information.

Step 614 includes the UE 602 transmitting an indication of the MG determined in step 612 to the BS 604. For example, the UE 602 may report the selection of the MG to the BS 604. The indication of the MG may include information identifying which carriers/BWPs are included in the MG, the types of measurement information that the MG corresponds to, and/or the preferred reference carrier(s)/BWP(s) for the MG. If multiple MGs are determined in step 612, then an indication of each of these MGs may be transmitted to the BS 604 in step 614. The UE 602 may also transmit “assistance information” to the BS 604 in step 614, which may include the AI/ML, positioning and/or sensing capabilities of the UE 602, to help the BS 604 configure the MG.

Step 616 includes the BS 604 determining a measurement configuration for the reference carrier/BWP of a MG. This MG may be based on a preferred MG determined by the UE 602 in step 612 and reported to the BS 604 in step 614. Alternatively, the MG may be selected by the BS 604. Similarly, the reference carrier/BWP of the MG may be a preferred carrier/BWP selected by the UE 602 in step 612, or may be a reference carrier/BWP selected by the BS 604. The measurement configuration determined for the reference carrier/BWP in step 616 may include both a measurement resource configuration and a measurement report configuration. In some implementations, multiple MGs are configured for the UE 602 by the BS 604, and a measurement configuration for the reference carrier/BWP of each MG may be determined in step 616.

A measurement resource configuration for a reference carrier/BWP enables the UE 602 to perform measurements on the reference carrier/BWP and obtain corresponding measurement information. These measurements may include intra-frequency measurements, inter-frequency measurements and/or inter-Radio Access Technology (RAT) measurements, for example. The measurement resource configuration may identify the reference carrier/BWP for the measurement and one or more measurement objects in that reference carrier/BWP. Non-limiting examples of measurement objects include a CSI-RS, an SRS and an SSB. The measurement resource configuration may also identify the type(s) of measurement information (i.e., measurement quantities) to be measured using a measurement object. For example, a measurement resource configuration may identify RSRP, RSRQ and/or SINR as the type(s) of measurement information to be measured. Further, the measurement resource configuration may indicate the time resources and/or frequency resources for a measurement, including a possible measurement gap. The frequency resources for the measurement may be some or all of the frequency resources of the reference carrier/BWP.

A measurement report configuration for a reference carrier/BWP enables the UE 602 to report the results of a measurement on the reference carrier/BWP. The measurement report configuration may include time-frequency resources for sending the measurement report. The measurement report configuration may also include a measurement report criterion or type, which defines a trigger for transmitting a measurement report. The measurement report type may indicate periodic measurement reporting or event-triggered measurement reporting.

Periodic measurement reporting specifies fixed time intervals for sending measurement reports. Once every interval, a UE may send a measurement report based on the most recently obtained measurement information.

In event-triggered measurement reporting, a measurement report may be sent based on whether or a not a defined measurement event has occurred. The measurement report configuration could specify the measurement events and specify conditions for each of the measurement events, such as a threshold for each event and/or a hysteresis value (or offset) for each event, for example. Non-limiting examples of measurement events include:
Event A1—the serving cell becomes better than a threshold;
Event A2—the serving cell becomes worse than threshold;
Event A3—a neighbor cell becomes better than a primary cell (PCell) of an MCG or a primary secondary cell (PSCell) of an SCG by an offset;
Event A4—a neighbor cell becomes better than threshold;
Event A5—a PCell or PSCell becomes worse than a first threshold and neighbor becomes better than a second threshold;
Event A6—a neighbor cell becomes better than SCell by an offset;
Event B1—an inter-RAT neighbor cell becomes better than threshold; and
Event B2—a PCell becomes worse than a first threshold and an inter-RAT neighbor cell becomes better than a second threshold.

Step 618 includes determining a measurement report configuration for the non-reference carrier(s)/BWP(s) in the MG group(s) configured for the UE 602. A measurement report configuration for a non-reference carrier/BWP may be similar to a measurement report configuration for the reference carrier/BWP determined in step 616. For example, a measurement report configuration determined in step 618 may include time-frequency resources for sending the measurement report and a measurement report type, which may be periodic or event-triggered. In the case that event-triggered measurement reporting is configured, the measurement report configuration for the non-reference carrier/BWP may specify the measurement events and optionally specify conditions for each of the measurement events.

After steps 616, 618, a measurement report configuration may have been determined for each of the carriers/BWPs in the MG(s) configured for the UE 602. Further, a measurement resource configuration has been determined for the reference carrier(s)/BWP(s) in the MG(s). Because non-reference carriers/BWPs are not physically measured by the UE 602, a measurement resource configuration might not have been determined for the non-reference carrier(s)/BWP(s) in the MG(s).

Step 620 includes the BS 604 transmitting the measurement configuration(s) determined in step 616 and the measurement report configuration(s) determined in step 618 to the UE 602. The measurement configuration(s) and the measurement report configuration(s) may be transmitted using control signaling.

Step 622 includes the UE 602 measuring the reference carrier/BWP of a MG based on the measurement resource configuration obtained in step 620. As a result, measurement information for the reference carrier/BWP is obtained by the UE 602. In the case that multiple MGs are configured for the UE 602, step 622 may include measuring the reference carrier/BWP of each of the MGs. The measurements of multiple reference carriers/BWPs may occur at different times.

Although measurements might not be performed on a non-reference carrier/BWP in a MG, a measurement object for a non-reference carrier/BWP may still be transmitted by the BS 604. However, the UE 602 might not perform measurements on this measurement object, and therefore potentially avoid implementing a measurement gap to perform the measurement.

In step 624, the UE 604 predicts measurement information for the non-reference carrier(s)/BWP(s) in a MG based on the measurement information for the reference carrier/BWP in the MG obtained in step 622. When multiple MGs are configured for the UE 602, step 624 may be performed for the non-reference carrier(s)/BWP(s) in each MG.

As noted above, predicting the measurement information for non-reference carriers/BWPs may be based on positioning information for the UE 602, mobility information for the UE 602 and/or sensing information for the UE 602. At least some of this information may have been obtained by the UE 602, for example, using the AI/ML, positioning and/or sensing capabilities of the UE 602. Alternatively or additionally, at least some of the information may have been obtained by the BS 604 and signaled to the UE 602. In some implementations, an AI/ML model is used to predict measurement information. The AI/ML model may be generated by the UE 602, or may be transmitted from the BS 604 to the UE 602.

Step 626 includes the UE 602 transmitting one or more measurement reports to the BS 604 based on the measurement information obtained in steps 622, 624. The measurement reports may be further based on the measurement report configurations obtained in step 620. The measurement reports transmitted in step 626 may relate to any, one, some or all of the carriers/BWPs in a MG, including reference and/or non-reference carriers/BWPs. If multiple MGs are configured for the UE 602, then the measurement reports may relate to carriers/BWPs in multiple MGs. Multiple measurement reports may be transmitted at multiple different times by the UE 602.

The timing or triggering of step 626 may depend on the measurement report configurations for the carriers/BWPs in a MG. In the case that periodic measurement reporting is configured for a carrier/BWP, then step 626 may be performed in accordance with the configured timing interval. Alternatively, in the case that event-triggered measurement reporting is configured for a carrier/BWP, then step 626 may be performed if the conditions for an event are met by the measurement information obtained in steps 622, 624.

Step 628 includes the BS 604 managing a carrier/BWP based on a measurement report received in step 626. For example, step 628 may include adding, removing, modifying, scheduling activating and/or deactivating the carrier/BWP for the UE 602, or performing a handover to or from the carrier/BWP. In one example, if a measurement report indicates that a type of measurement information for a carrier/BWP in a MG exceeds a threshold, then that carrier/BWP may be added and/or activated for the UE 602. In another example, if a measurement report indicates that a type of measurement information for a carrier/BWP in a MG is below a threshold, then that carrier/BWP may be removed and/or deactivated for the UE 602.

Step 628 may include the BS 604 transmitting control signaling to the UE 602 to manage a carrier/BWP. The control signaling may instruct the UE 602 to add, remove, modify, activate and/or deactivate a carrier/BWP. In some implementations, the UE 602 may activate or deactivate a carrier/BWP in advance of sending a measurement report to the BS 604 and/or in advance of receiving control signaling from the BS 604 to activate or deactivate the carrier/BWP. This may reduce the configuration or activation time for the carrier/BWP, as the UE 602 does not need to wait for an instruction from the BS 604.

A MG need not always be determined by a UE. In some embodiments, a MG group is at least partially determined by a BS. Further, the BS may predict the measurement information for a non-reference carrier/BWP in the MG. This may be referred to as BS-triggered intelligent measurement or intelligent measurement prediction at the BS side. The UE may report some information to assist the BS in configuring the MG and/or to assist the BS in predicting the measurement information for a non-reference carrier/BWP.

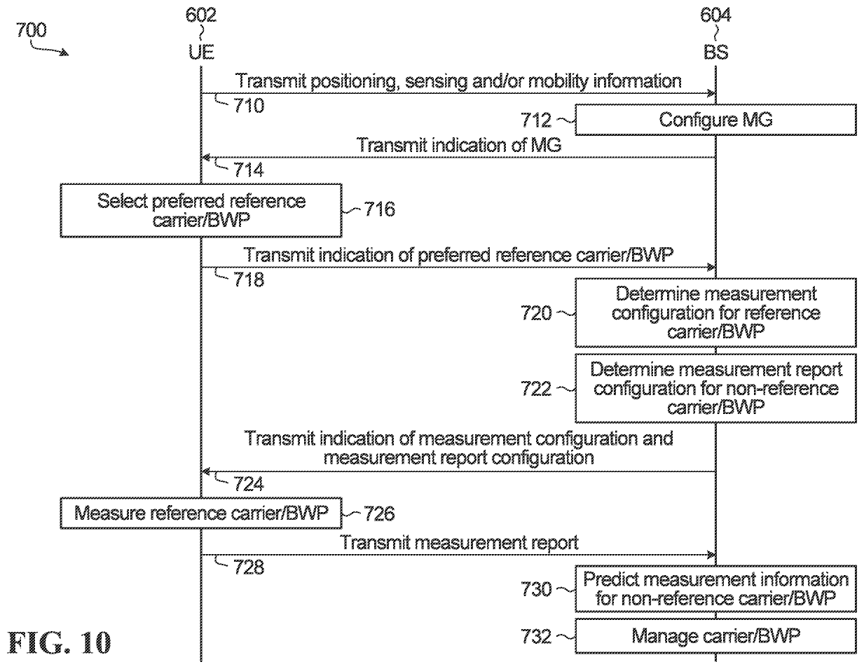

FIG. 10 is a signaling diagram illustrating a BS-triggered intelligent measurement process 700, according to an embodiment. The process 700 provides an example of the BS 604 configuring a MG and predicting measurement information for non-reference carriers/BWPs in the MG.

Step 710 is an optional step that includes the UE 602 transmitting assistance information to the BS 604, which may assist the BS 604 in configuring a MG for the UE 602. This assistance information may include position information for the UE 602, sensing information for the UE 602, and/or mobility information for the UE 602. In some sense, the assistance information may indicate the state of the UE 602.

In step 712, the BS 604 configures a MG for the UE 602, optionally based on the assistance information obtained in step 710. The BS 604 may also or instead configure the MG based on the AI/ML, positioning and/or sensing capabilities of the UE 602. The BS 604 may determine the carriers and/or BWPs included in the MG, as well as the type(s) of measurement information that the MG corresponds to. The BS 604 may also select one or more candidate reference carriers/BWPs for the MG.

According to one example implementation of step 712, the BS 604 may determine that the position of the UE 602 is in the center of a cell (i.e., the UE 602 might not be near the edge of a cell). This position may be indicated through assistance information received in step 710, for example. First and second carriers/BWPs in the same frequency band are assigned to the UE 602, and the BS 604 may be able to predict measurement information for the first carrier/BWP based on a measurement of the second carrier/BWP. Based on this ability, the first and second carriers/BWPs may be assigned to the same MG. Further, the second carrier/BWP may be selected as a candidate reference carrier/BWP.

In some implementations, the BS 604 may configure multiple MGs in step 612, where each MG may include different carriers/BWPs and/or correspond to one or more different type(s) of measurement information. While steps 714, 716, 718, 720, 722, 724, 726, 728, 730, 732 are generally described below in the context of a single MG, it should be noted that if multiple MGs are configured for the UE 602, then these steps may be performed for each MG.

Step 714 includes the BS 604 transmitting an indication of the MG configured in step 712 to the UE 602, optionally using control signaling. In other words, the BS 604 may report the configuration of the MG to the UE 602. The indication of a MG may include information identifying which carriers/BWPs are included in the MG, the type(s) of measurement information the MG corresponds to, and/or the candidate reference carrier(s)/BWP(s) for the MG.

If multiple candidate reference carriers/BWPs for the MG are reported to the UE 602 in step 714, then the UE may perform optional steps 716, 718. Step 716 includes the UE 602 selecting a preferred reference carrier/BWP from the multiple candidate reference carriers/BWPs. As outlined above, the selection of the preferred reference carrier/BWP may be based on the capabilities and/or preferences of the UE 602. Step 718 then includes the UE 602 transmitting an indication of the preferred reference carrier/BWP to the BS 604.

Alternatively, if only one candidate reference carrier/BWP is reported in step 714, then this may be treated as the reference carrier/BWP by the UE 602 and steps 716, 718 may be omitted.

Step 720 includes the BS 604 determining a measurement configuration for the reference carrier/BWP of a MG, and step 722 includes the BS 604 determining a measurement report configuration for one or more non-reference carrier(s)/BWP(s) in the MG. Examples of measurement configurations and measurement reporting configurations are described above with reference to steps 616, 618 of FIG. 9.

The measurement report configuration for the reference carrier/BWP may include periodic measurement reporting or event-triggered measurement reporting. The measurement report configuration for a non-reference carrier/BWP may also include periodic measurement reporting or event-triggered measurement reporting. In some implementations, the measurement report configuration (which may include event-triggered measurement reporting) for one or more non-reference carrier(s)/BWP(s) in the MG includes one or more conditions that are based on measurement information for the reference carrier/BWP. These conditions may be referred to as “report measurement conditions”. A report trigger condition could define when the UE 602 sends a measurement report for a non-reference carrier/BWP to the BS 604. By way of example, a report trigger condition may be defined as: if ff(M_{R})>threshold, then send a measurement report, where ff( ) is a function defined by the BS 604, M_{R} is measurement information for the reference carrier/BWP (for example, a measured RSRP, RSRQ and/or SINR for the reference carrier/BWP), and threshold is a constant defined or configured by the BS 604. As such, a report trigger condition can use measurement information for a reference carrier/BWP to dictate whether or not the UE 602 should transmit a measurement report for a non-reference carrier/BWP.

In step 724, an indication of the measurement configuration for the reference frequency determined in step 720 and the measurement report configuration(s) for the one or more non-reference carrier(s)/BWP(s) determined in step 722 are transmitted to the UE 602.

Step 726 includes the UE 602 performing measurements on the reference carrier/BWP of the MG, according to the measurement configuration received in step 724.

Step 728 includes the UE 602 transmitting a measurement report to the BS 604 for a carrier/BWP in the MG. In some implementations, step 728 may be based on the measurement information obtained in step 726 and/or the measurement report configurations received in step 724.

In the case that periodic measurement reporting is configured for a carrier/BWP, then step 728 may be performed in accordance with the configured timing. In the case that event-triggered measurement reporting is configured for the reference carrier/BWP, then a measurement report may be sent if the conditions for an event are satisfied by the measurement information obtained in step 726. Further, in the case that a report trigger condition is configured for a non-reference carrier/BWP, then a measurement report may be sent if the report trigger condition is satisfied by the measurement information obtained in step 726.

A measurement report for the reference carrier/BWP may include the measurement information obtained in step 726. A measurement report for a non-reference carrier/BWP may also include the measurement information obtained for the reference carrier/BWP obtained in 726, which could be used by the BS 604 to predict measurement information for the non-reference carrier/BWP. Alternatively or additionally, a measurement report for a non-reference carrier/BWP may include measurement information that is determined or predicted for the non-reference carrier/BWP. This measurement information for the non-reference carrier/BWP could be determined based on the measurement information for the reference carrier/BWP. For example, an RSRP of the non-reference carrier may be equal to ff(M_{R}), and the UE 602 may report the value of ff(M_{R}) to the BS 604 in step 728. The function ff( ) may have been configured by the BS 604 and sent to the UE 602.

In step 730, after receiving a measurement report for a non-reference carrier/BWP in the MG, the BS 604 predicts or otherwise determines measurement information for the non-reference carrier/BWP. As noted above, predicting the measurement information for a non-reference carrier/BWP may be based on positioning information for the UE 602, mobility information for the UE 602 and/or sensing information for the UE 602. This information may have been obtained in step 710, for example. In some implementations, an AI/ML model is used to predict measurement information.

Step 732 includes the BS 604 managing a carrier/BWP in the MG, which may include adding, removing, modifying, scheduling, activating and/or deactivating the carrier/BWP, or performing a handover to or from the carrier/BWP. The reference carrier/BWP in the MG may be managed based on a measurement report received in step 728. A non-reference carrier/BWP in the MG, on the other hand, may be managed based on the measurement information predicted in step 730.

Advantageously, in the processes 600, 700, only the reference carrier/BWP is actually measured by the UE 602 in a MG, but the UE 602 can still send a measurement report for any carrier/BWP in the MG to the BS 604. This may reduce the overhead for the measurement of the carriers/BWPs in the MG, and in particular reduce the overhead associated with measurement gaps.

### Inter-Carrier/BWP Measurements

Another example of measurement overhead is a scheduling latency caused by obtaining measurement information for an inactive carrier/BWP. For example, a configured carrier/BWP at UE may be inactive to save power at the UE. Before scheduling a transmission on an inactive carrier, measurement information for the inactive carrier might first need to be obtained. The time needed to perform a measurement to obtain this measurement information may contribute to scheduling latency.

An aspect of the present disclosure relates to a concept of inter-carrier/BWP measurements. An inter-carrier/BWP measurement enables a measurement on a configured carrier that might not be active for data transmission and/or reception at a UE. An inter-carrier/BWP measurement may also enable measurements on multiple different configured carriers/BWPs during a single measurement period. Each configured carrier/BWP may be measured sequentially in the measurement period in a predefined or dynamically configured order. A single transmit and/or receive (Tx/Rx) radio frequency (RF) chain and/or antenna (RF/antenna) may be switched between the different carriers/BWPs in the inter-carrier/BWP measurement.

Potential technical advantages of an inter-carrier/BWP measurement over conventional schemes include obtaining measurement information for configured carriers/BWPs that may be later used for data transmission according to indications from a BS. When the data arrives for transmission to/from a UE, the BS can schedule the data without delay since the channel information is obtained in advance, thereby achieving low latency scheduling. Further, by switching an RF/antenna between configured carriers/BWPs during an inter-carrier/BWP measurement, the use of multiple different Tx/Rx RFs/antennas for measurements may be avoided. An inter-carrier/BWP measurement may provide a reduction in power consumption at a UE configured with multiple carriers/BWPs, as the carriers/BWPs are not always active and are only active during the measurement period.

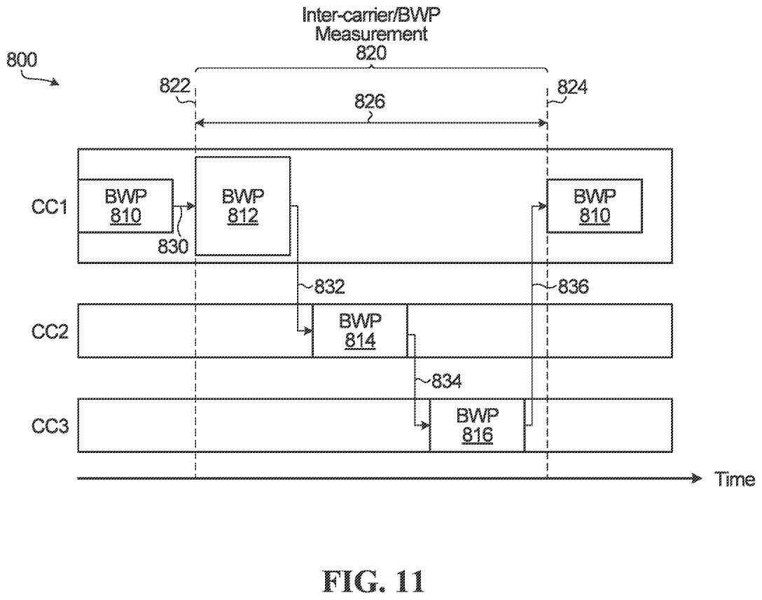

FIG. 11 illustrates a time-frequency resource allocation 800 including a configured inter-carrier/BWP measurement 820, according to an embodiment. The resource allocation 800 is configured for a UE. The resource allocation 800 includes three CCs labelled as “CC1”, “CC2” and “CC3”. CC1 includes an active BWP 810 and a configured BWP 812, CC2 includes a configured BWP 814, and CC3 includes a configured BWP 816. The active BWP 810 is used for data transmission to and/or from the UE. The configured BWPs 812, 814, 816 are inactive but configured for possible data transmission according to a BS indication. If the BS activates one of the configured BWPs 812, 814, 816, then the UE may perform data transmission or measurement in the BWP.

As illustrated, the BWP 810 includes a relatively small bandwidth compared to the total bandwidth provided by other BWPs 812, 814, 816. The BWPs 812, 814, 816 may have been deactivated to save power at the UE. By way of example, if the UE only requires a relatively small data transmission rate over the time period shown in FIG. 11, then the BWP 810 might provide enough bandwidth to facilitate that data transmission rate. The BWPs 812, 814, 816 may therefore be deactivated to save power at the UE. However, the BWPs 812, 814, 816 may remain configured at the UE to accommodate a large burst of traffic. If such a burst of traffic occurs, then one or more of the BWPs 812, 814, 816 may be activated (through dynamic control signaling such as DCI, for example) to increase the number of carriers and/or BWPs available for the UE.

In order to activate and utilize one or more of the BWPs 812, 814, 816 in the event of a large burst of data traffic, measurement information (for example, channel information such as CSI) for the BWPs 812, 814, 816 may need to be obtained. In some cases, the measurement information should be rapidly available to avoid a delay in activating and scheduling transmissions on the BWPs 812, 814, 816. In FIG. 11, the inter-carrier/BWP measurement 820 is implemented to obtain measurement information for the BWPs 812, 814, 816 in a power-efficient manner while the BWPs 812, 814, 816 are inactive for the purposes of data transmission and/or reception. This measurement information may enable one or more of the BWPs 812, 814, 816 to be rapidly activated in the event of a large burst of data traffic.

The inter-carrier/BWP measurement 820 occurs over a measurement period 826 that is defined by a start time 822 and an end time 824. As shown in FIG. 11, prior to the start time 822 of the measurement period 826, the UE is transmitting and/or receiving data on the BWP 810. At the start time 822, the measurement period 826 of the inter-carrier/BWP measurement 820 begins. The UE switches from transmitting and/or receiving data on the BWP 810 to performing a measurement on the BWP 812, as indicated at 830 in FIG. 11. After performing the measurement on the BWP 812, the UE then switches to performing a measurement on BWP 814 (as shown at 832), then switches to performing a measurement on BWP 816 (as shown at 834), and then switches back to transmitting and/or receiving data on the BWP 810 (as shown at 836). In this way, the UE sequentially switches between performing measurements on the BWPs 812, 814, 816 during the measurement period 826.

The measurements performed on the BWPs 812, 814, 816 may include a downlink measurement, an uplink measurement, a beam measurement, a synchronization measurement, and/or a timing advance measurement. In some implementations, a CSI-RS is measured on the each of the BWPs 812, 814, 816 during the inter-carrier/BWP measurement 820.

The switching between the BWPs 810, 812, 814, 816 indicated at 830, 832, 834, 836 may be performed by radio frequency (RF) switching or RF bandwidth adaption. As illustrated, RF switching and/or RF bandwidth adaptation may induce a time delay. For example, the switching indicated at 830 results in a time delay between transmitting and/or receiving data on the BWP 810 and performing a measurement on the BWP 812.

The same Rx/Tx RF/antenna of the UE may be used to perform the inter-carrier/BWP measurement 820. For example, the same Rx/Tx RF/antenna may be switched between the BWPs 810, 812, 814, 816.

In the illustrated example, a measurement gap is implemented during the inter-carrier/BWP measurement 820. For example, the UE does not transmit or receive data on CC1 while measuring the BWP 814 on CC2 and the BWP 816 on CC3. In other embodiments, a measurement gap might not be implemented if the RF capabilities of the UE permit measurement on one carrier while transmitting/receiving on another carrier. For example, in these embodiments, the UE may transmit and/or receive data on the BWP 810 while performing measurements on the BWPs 814, 816.

The UE may temporarily activate each of the BWPs 812, 814, 816 to perform the inter-carrier/BWP measurement 820. After performing a measurement on each of the BWPs 812, 814, 816, the UE may enter a power saving mode for the BWP and optionally for the associated carrier. For example, after performing the measurement on the BWP 814, the UE may enter a power saving mode for the BWP 814 and CC2. Entering the power saving mode may include deactivating the BWP 814 and CC2. During the power saving mode, the physical downlink control channel (PDCCH) might not be monitored on the BWP 814 and CC2, there might be no data transmission or reception on the BWP 814 and CC2, there might be no measurement on the BWP 814 and CC2, and/or the RF capabilities might be turned off for the BWP 814 and CC2.

In the illustrated example, the inter-carrier/BWP measurement 820 includes measurements of multiple different carriers (for example, CC1, CC2 and CC3) and multiple different BWPs (for example, the BWPs 812, 814, 816). In other embodiments, an inter-carrier/BWP measurement may perform measurements on one carrier and/or on one BWP.

In some implementations, the inter-carrier/BWP measurement period 820 is configured by a BS through control signaling, such as by RRC signaling, a MAC CE or DCI, for example. The BS may configure the BWPs 812, 814, 816 measured in the inter-carrier/BWP measurement period 820 and/or the measurement order of the BWPs 812, 814, 816. However, the measurement order of the BWPs 812, 814, 816 may instead be dynamically indicated through DCI, for example. The BS may configure the UE to implement the inter-carrier/BWP measurement 820 in predefined measurement periods (for example, in semi-persistent measurement periods). Alternatively, the inter-carrier/BWP measurement 820 may be implemented in dynamically configured measurement periods. For example, the BS may have configured the UE to implement the inter-carrier/BWP measurement 820 in the measurement period 826 because the UE is not monitoring the PDCCH during this period and/or is not expected to send or receive a data transmission during this period.

### General Examples

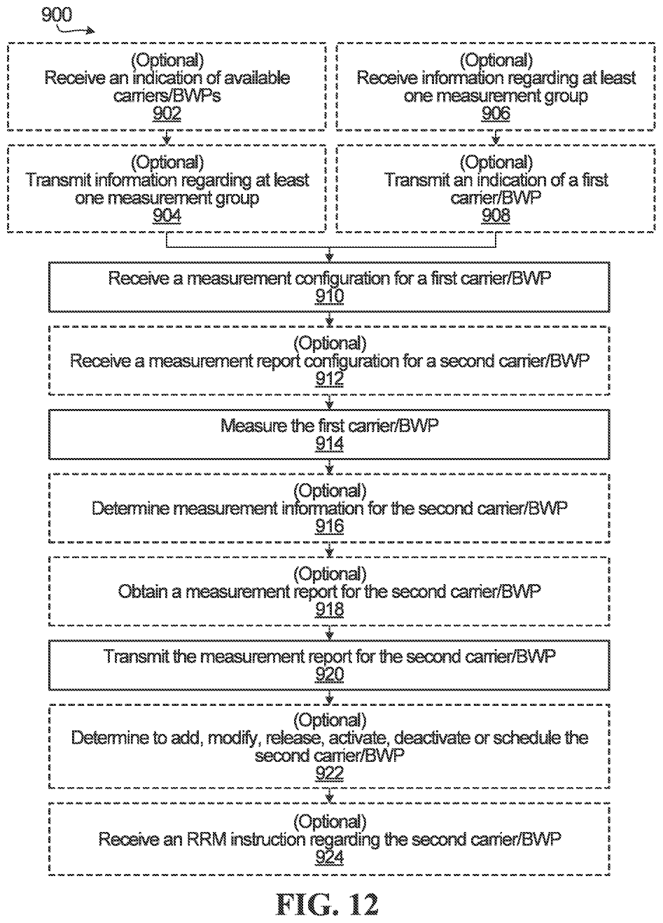

FIG. 12 is a flow diagram illustrating a method 900 for an apparatus in a wireless communication network, according to an embodiment. In some implementations, the apparatus is a UE or ED, such as the ED 110 of FIGS. 1 to 3, for example. The method 900 will be described as being performed by an apparatus having at least one processor, a computer readable storage medium, a transmitter and a receiver. In some implementations, the computer readable storage medium is operatively coupled to the at least one processor and stores programming for execution by the at least one processor. The programming may include instructions to perform the method 900.

In some implementations, the method 900 may form part of a measurement process involving a first MG. For example, the method 900 may be implemented by the UE 602 in the measurement processes 600, 700 of FIGS. 9 and 10. The first MG includes a first carrier/BWP that is a reference carrier/BWP and a second carrier/BWP that is a non-reference carrier/BWP. Other non-reference carriers/BWPs may also be included in the first MG.

In some implementations, the method 900 includes the apparatus determining or suggesting at least one MG. In these cases, optional steps 902, 904 may be performed. Step 902 includes the receiver of the apparatus receiving an indication of available carriers/BWPs for the apparatus. The available carriers/BWPs may include carriers/BWPs that are configured and/or active for the apparatus. This indication may be sent by a network device such as a BS that is serving the apparatus. For example, indication received in step 902 may be similar to the indication sent in step 610 of the process 600.

Step 904 includes the transmitter of the apparatus transmitting information regarding at least one MG, including the first MG. The information transited in step 904 may identify the carriers/BWPs in the first MG, identify at least one preferred reference carrier/BWP for the first MG, and/or identify the types of measurement information that the first MG corresponds to. The information may be transmitted to the network device. In some implementations, step 904 is similar to step 614 of the process 600. After receiving the information in step 904, the network device may configure the first MG for the apparatus based on the information.

MGs may be determined by the UE based on any of a variety of different factors. In some implementations, the information regarding the at least one MG is based on at least one of an AI capability, a sensing capability or a position of the apparatus. Alternatively or additionally, the information regarding the at least one MG may be based on the available carriers/BWPs indicated in step 902.

In some implementations, the method 900 includes the network device determining or suggesting at least one MG. In these cases, optional steps 906, 908 may be performed. Step 906 includes a receiver of the apparatus receiving, from the network device, information regarding at least one MG, including the first MG. For example, step 906 may be similar to step 714 of the process 700. In some implementations, the at least one MG may have been determined by the network device on based on at least one of an AI capability, a sensing capability or a position of the apparatus. The transmitter of the apparatus may have transmitted assistance information to the network device that includes the AI capability, sensing capability and/or the position of the apparatus.

In some implementations, the information received in step 906 may identify the carriers/BWPs in the first MG, identify one or more candidate reference carriers/BWPs for the first MG, and/or identify the types of measurement information that the first MG corresponds to. If the information identifies a plurality of candidate reference carriers/BWPs, then the apparatus may perform optional step 908. Step 908 includes the transmitter of the apparatus transmitting, to the network device, an indication of the first carrier/BWP from the plurality of candidate reference carriers/BWPs. In this way, the apparatus may select the reference carrier/BWP for the first MG.

Step 910 includes the receiver of the apparatus receiving, from a network device, a measurement configuration for the first carrier/BWP of the first MG. As noted above, the first carrier/BWP is a reference carrier/BWP of the first MG. The measurement configuration may include at least one of the following: a measurement object; a measurement quantity or measurement type; measurement resources including at least one of time resources or frequency resources; a measurement report configuration; or a measurement gap.

Step 912 is an optional step that includes the receiver of the apparatus receiving, from the network device, a measurement report configuration for the second carrier/BWP of the first MG, which is a non-reference carrier/BWP of the MG. The measurement report configuration may include at least one of the following: a measurement report type or criterion (for example, event-triggered measurement reporting or periodic measurement reporting); a time interval for measurement reporting (for example, in the case of periodic measurement reporting); a measurement event (for example, in the case of event-triggered measurement reporting); a condition for triggering of a measurement report (for example, a threshold, hysteresis value and/or report trigger condition); or a measurement report type or quantity (for example, the type of measurement information included in a measurement report). Further examples of measurement report configurations are provided elsewhere herein.

Step 620 of the process 600 and step 724 of the process 700 provide example implementations of steps 910, 912.

Step 914 includes the at least one processor of the apparatus measuring the first carrier/BWP based on the measurement configuration received in step 910 to obtain measurement information for the first carrier/BWP. Examples of measurement information are provided elsewhere herein. Step 914 could be similar to step 622 of the process 600 and/or to step 726 of the process 700.

Step 914 could be implemented in any of a number of different ways. In some implementations, step 914 includes the receiver of the apparatus receiving a measurement object (for example, a CSI-RS or SSB) corresponding to the first carrier/BWP. The at least one processor of the apparatus may then extract waveform parameters from the measurement object to determine the measurement information for the first carrier/BWP.

Step 916 is an optional step that includes the at least one processor of the apparatus predicting or otherwise determining measurement information for the second carrier/BWP based on the measurement information for the first carrier and/or the first BWP. The measurement information for the second carrier/BWP may also be based on at least one of: position information, mobility information or sensing information for the apparatus. Further details regarding determining measurement information for a non-reference carrier/BWP are provided elsewhere herein, such as with reference to step 624 of the process 600, for example.

In some implementations, the measurement information for the second carrier/BWP includes at least one of: intra-frequency measurement results, inter-frequency measurement results, or inter-RAT measurement results. Alternatively or additionally, the measurement information for the second carrier/BWP may include at least one of: beam-level measurement results, BWP-level measurement results, carrier-level measurement results, or cell-level measurement results.

Step 918 is an optional step that includes the at least one processor generating or otherwise obtaining a measurement report for the second carrier/BWP based on the measurement report configuration received in step 912. The measurement report for the second carrier/BWP is also based on the measurement information for the first carrier/BWP obtained in step 914. In some implementations, the measurement report includes the measurement information for the first carrier/BWP obtained in step 914, which could be used by the network device to determine measurement information for the second carrier/BWP. Alternatively or additionally, the measurement report for the second carrier/BWP includes or is otherwise based on the measurement information for the second carrier/BWP determined in step 916.

Step 920 includes the transmitter of the apparatus transmitting, to the network device, the measurement report for the second carrier/BWP that may have been obtained in step 918. Example implementations of step 920 include step 626 of the process 600 and step 728 of the process 700.

Step 922 is an optional step that includes the at least one processor of the apparatus determining, based on the measurement information for the second carrier/BWP determined in 916, to perform at least one of: addition, modification, release, activation, deactivation or scheduling of the second carrier/BWP. For example, the apparatus may perform step 922 in advance of receiving RRM signaling in order to avoid a delay associated with the RRM signaling. In some implementations, step 922 might also be performed before obtaining and/or transmitting the measurement report in steps 918, 920.

Step 924 is an optional step that includes the receiver of the apparatus receiving, from the network device, an RRM instruction regarding the second carrier/BWP. The RRM instruction may be based on the measurement report for the second carrier/BWP transmitted in step 920. The RRM instruction may include an instruction indicating at least one of: addition, modification, release, activation, deactivation, or scheduling of the second carrier/BWP, or indicating, handover to or handover from the second carrier/BWP, for example

It should be noted that the method 900 is not limited to the first MG. Multiple MGs could be configured for the apparatus. For example, the information transmitted in step 904 or the information received in step 906 may relate to the first MG and a second MG. The first MG may correspond to first types of measurement information and the second MG may correspond to second types of measurement information, which may be at least partially different from the first types of measurement information. Examples of different types of measurement information are provided elsewhere herein. Further, the second MG may include a third carrier/BWP that is a non-reference carrier/BWP and a fourth carrier/BWP that is a reference carrier/BWP. The first and second MGs may the same or different. For example, the first and/or second carriers/BWP might be the same as or different from the third and/or fourth carriers/BWPs. Any, one, some or all of steps 910, 912, 914, 916, 918, 920, 922, 924 may be performed for the second MG. For example, the method 900 may further include transmitting, by the transmitter of the apparatus to the network device, a measurement report for the third carrier/BWP, where the measurement report for the third carrier/BWP is based on measurement information for the fourth carrier/BWP.

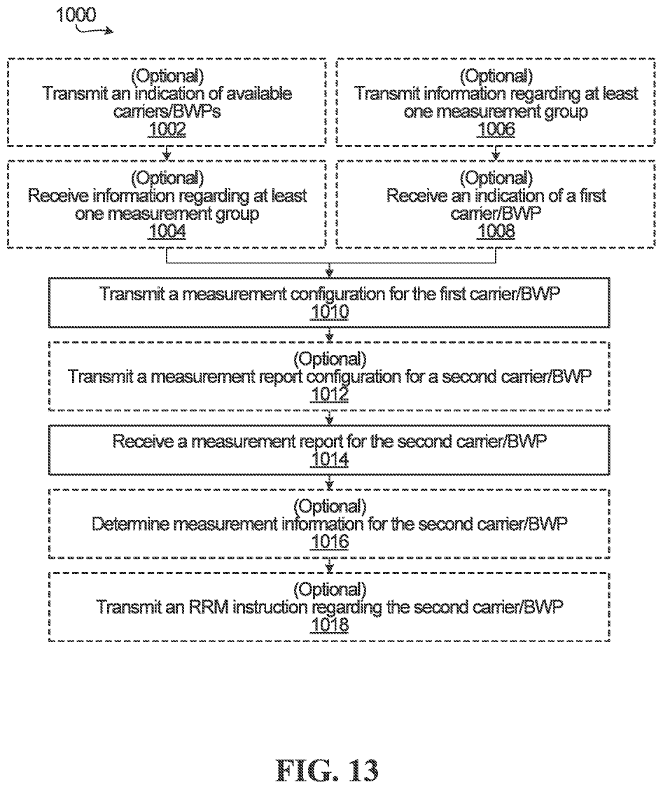

FIG. 13 is a flow diagram illustrating a method 1000 for network device in a wireless communication network, according to an embodiment. In some implementations, the network device is a BS or a TRP, such as the T-TRP 170 or the NT-TRP 172 of FIGS. 1 to 3, for example. The method 1000 will be described as being performed by a network device having at least one processor, a computer readable storage medium, a transmitter and a receiver. In some implementations, the computer readable storage medium is operatively coupled to the at least one processor and stores programming for execution by the at least one processor. The programming may include instructions to perform the method 1000.

In some implementations, the method 1000 forms part of a measurement process involving a first MG configured for an apparatus. For example, the method 1000 may be implemented by the BS 604 in the measurement processes 600, 700 of FIGS. 9 and 10. The first MG includes a first carrier/BWP that is a reference carrier/BWP and a second carrier/BWP that is a non-reference carrier/BWP. Other non-reference carriers/BWPs may also be included in the first MG.

In some implementations, the method 1000 includes the apparatus determining or suggesting at least one MG. In these cases, optional steps 1002, 1004 may be performed. Step 1002 is an optional step that includes the transmitter of the network device transmitting, to the apparatus, an indication of available carriers/BWPs for the apparatus. Step 1004 is another optional step that includes the receiver of the network device receiving, from the apparatus, information regarding at least one MG, including the first MG. This information may be based on the available carriers/BWPs for the apparatus transmitted in step 1002. Examples of information regarding at least one MG are provided above with reference to FIG. 12.

In some implementations, the information regarding the at least one MG received in step 1002 includes an indication of at least one preferred reference carrier/BWP for the first MG. The network device may then select the first carrier/BWP from the at least one preferred reference carrier/BWP.

Steps 610, 614 of the process 600 provide example implementations of steps 1002, 1004, respectively.

In some implementations, the method 1000 includes the network device determining at least one MG. In these cases, optional steps 1006, 1008 may be performed. Step 1006 includes the transmitter of network device transmitting, to the apparatus, information regarding at least one MG including the first MG. This information may be based on at least one of an AI capability, a sensing capability or a position of the apparatus, which may have been previously sent to the network device from the apparatus in the form of assistance information, for example.

In some implementations, the information regarding the at least one MG includes a plurality of candidate reference carriers/BWPs. Optional step 1008 includes the receiver of the network device receiving, from the apparatus, an indication of the first carrier/BWP from the plurality of candidate reference carriers/BWPs. For example, the apparatus may have selected the first carrier/BWP as the reference carrier/BWP from the plurality of candidate reference carriers/BWPs. Steps 714, 718 of the process 700 provide example implementations of steps 1006, 1008, respectively.

Step 1010 includes the transmitter of the network device transmitting, to the apparatus, a measurement configuration that may be used to obtain measurement information for the first carrier/BWP. The measurement configuration may include at least one of the following: a measurement object; a measurement quantity; measurement resources including at least one of time resources or frequency resources; a measurement report configuration; or measurement gap.

Step 1012 is an optional step that includes the transmitter of the network device transmitting, to the apparatus, a measurement report configuration for the second carrier/BWP of the first MG. This measurement report configuration may include at least one of the following: a measurement event; a condition for triggering a measurement report; a measurement report quantity; a measurement report type; or a time interval for measurement reporting.

Step 620 of the process 600 and step 724 of the process 700 provide example implementations of steps 1010, 1012.

Step 1014 includes the receiver of the network device receiving, from the apparatus, a measurement report for the second carrier/BWP. The measurement report for the second carrier/BWP is based on the measurement information for the first carrier/BWP obtained using the measurement configuration transmitted in step 1010. The measurement report for the second carrier/BWP may also be based on the measurement report configuration transmitted in step 1012. Step 626 of the process 600 and step 728 of the process 700 are example implementations of step 1014.

In some implementations, the measurement report for the second carrier/BWP includes the measurement information for the first carrier/BWP. Step 1016 is an optional step that includes the at least one processor of the network device determining measurement information for the second carrier/BWP based on the measurement information for the first carrier/BWP. As discussed elsewhere herein, step 1016 may be performed based on at least one of position information, mobility information or sensing information for the apparatus. The measurement information for the second carrier/BWP may include at least one of: intra-frequency measurement results, inter-frequency measurement results, or inter-RAT measurement results. Further, the measurement information for the second carrier/BWP may include at least one of: beam-level measurement results, BWP-level measurement results, carrier-level measurement results, or cell-level measurement results.

Optional step 1018 includes the transmitter of the network device transmitting, to the apparatus, an RRM instruction regarding the second carrier/BWP. The RRM instruction may be based on the measurement report for the second carrier/BWP received in step 1014 and/or on the measurement information for the second carrier/BWP determined in step 1016. The RRM instruction could include an instruction indicating at least one of: addition, modification, release, activation, deactivation, or scheduling of the second carrier/BWP, or indicating, handover to or handover from the second carrier/BWP.

Similar to the method 900, the method 1000 is not limited to the first MG for the apparatus. For example, the information received in step 1004 or the information transmitted in step 1006 may relate to the first MG and a second MG. The first MG may correspond to first types of measurement information and the second MG may correspond to second types of measurement information. Further, the second MG may include a third carrier/BWP that is a non-reference carrier/BWP and a fourth carrier/BWP that is a reference carrier/BWP. The first and second MGs may the same or different. Any, one, some or all of steps 1010, 1012, 1014, 1016, 1018 may be performed for the second MG. For example, the method 1000 may further include receiving, by the receiver of the network device from the apparatus, a measurement report for the third carrier/BWP, where the measurement report for the third carrier/BWP is based on measurement information for the fourth carrier/BWP.

The methods 900, 1000 include the use of MGs to obtain measurement reports in a wireless communication system. In both the methods 900, 1000, only the first carrier/BWP in the first MG is actually measured by an apparatus. However, a measurement report is still obtained for the second carrier/BWP. This may avoid performing an actual measurement on the second carrier/BWP, and therefore may reduce measurement overhead at the apparatus.

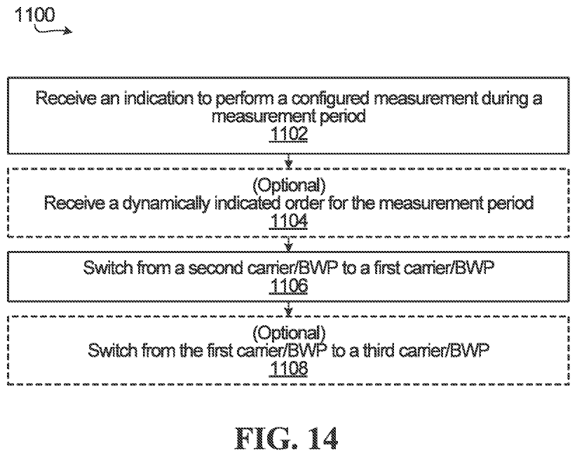

FIG. 14 is a flow diagram illustrating a method 1100 for an apparatus in a wireless communication network, according to another embodiment. In some implementations, the apparatus is a UE or ED, such as the ED 110 of FIGS. 1 to 3, for example. The method 1100 will be described as being performed by an apparatus having at least one processor, a computer readable storage medium, a transmitter and a receiver. In some implementations, the computer readable storage medium is operatively coupled to the at least one processor and stores programming for execution by the at least one processor. The programming may include instructions to perform the method 1100.

Step 1102 includes the receiver of the apparatus receiving, from a network device, an indication to perform a configured measurement during a measurement period. This indication may be received in control signaling for example. The configured measurement may include a measurement of a first carrier/BWP during a first portion of the measurement period. The measurement period may be scheduled after a transmission and/or reception on a second carrier/BWP. Additionally, the configured measurement may further include a measurement of a third carrier/BWP during a second portion of the measurement period. The measurement of the first carrier/BWP and/or the third carrier/BWP may include a CSI measurement, for example. The first carrier/BWP and/or the third carrier/BWP may be configured carriers/BWPs at the apparatus that are inactive for data transmission at the apparatus during the measurement period. In some cases, the configured measurement is an example of an inter-carrier/BWP measurement that may be similar to the inter-carrier/BWP measurement 820 of FIG. 11, for example.

In some implementations, the configured measurement may be indicated to the apparatus in step 1102. Alternatively, the configured measurement may be already known to the apparatus, and step 1102 includes an indication to perform the configured measurement during the measurement period.

In some implementations, configured measurement includes a preconfigured order for the first portion and the second portion of the measurement period. Alternatively, the order of the first portion and the second portion of the measurement period may be dynamically indicated. Optional step 1104 includes the receiver of the apparatus receiving, from the network device, in DCI or MAC signaling (for example, in a MAC CE), the dynamically indicated order for the first portion and the second portion of the measurement period. The dynamically indicated order may be received in the same control signaling as the indication to perform the configured measurement in step 1102. Alternatively, the dynamically indicated order may be received separately from the indication to perform the configured measurement in step 1102. In some cases, step 1104 may occur before step 1102.

Step 1106 includes the at least one processor of the apparatus switching from the second carrier/BWP to performing the measurement of the first carrier/BWP during the first portion of the measurement period. For example, the apparatus may be transmitting and/or receiving data on the second carrier/BWP before the measurement period, and then switch to performing the measurement of the first carrier/BWP during the first portion of the measurement period. In some implementations, step 1106 may include RF/antenna switching and/or RF bandwidth adaptation.

Step 1108 is an optional step that includes the at least one processor of the apparatus switching from the first carrier/BWP to performing the measurement of the third carrier/BWP during the second portion of the measurement period.

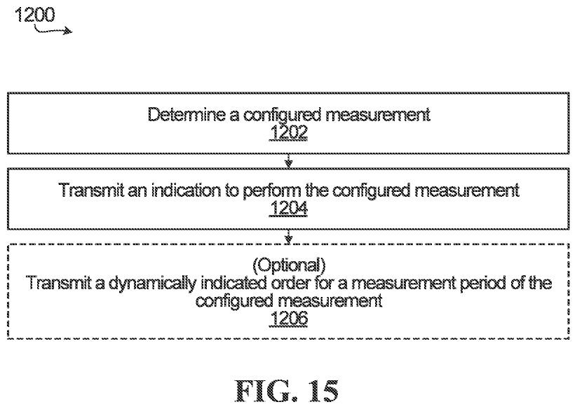

FIG. 15 is a flow diagram illustrating a method 1200 for network device in a wireless communication network, according to another embodiment. In some implementations, the network device is a BS or TRP, such as the T-TRP 170 or the NT-TRP 172 of FIGS. 1 to 3, for example. The method 1200 will be described as being performed by a network device having at least one processor, a computer readable storage medium, a transmitter and a receiver. In some implementations, the computer readable storage medium is operatively coupled to the at least one processor and stores programming for execution by the at least one processor. The programming may include instructions to perform the method 1200.

Step 1202 includes the at least one processor of the network device determining a configured measurement for an apparatus. The configured measurement may include a measurement of a first carrier/BWP during a first portion of a measurement period, which may occur after a scheduled transmission and/or reception on a second carrier/BWP at the apparatus. Further, the configured measurement may include a measurement of a third carrier/BWP during a second portion of the measurement period. The configured measurement is an example of an inter-carrier/BWP measurement, which may be similar to the inter-carrier/BWP measurement 820 of FIG. 11.

Step 1204 includes the transmitter of the network device transmitting, to an apparatus in control signaling, an indication to perform the configured measurement. For example, the indication to perform the configured measurement may include an indication for the apparatus to switch from the second carrier/BWP to perform the measurement of the first carrier/BWP during the first portion of the measurement period. The indication to perform the configuration measurement may also include an indication for the apparatus to switch from the first carrier/BWP to perform the measurement of the third carrier/third BWP during the second portion of the measurement period. The measurement of the first carrier/BWP and/or the third carrier/BWP may include a CSI measurement. The first carrier/BWP and/or the third carrier/BWP may be inactive for data transmission at the apparatus during the measurement period.

In some implementations, the configured measurement is indicated to the apparatus in step 1204. Alternatively, the apparatus might already know the configured measurement, and step 1204 includes indicating the apparatus to perform the configured measurement during the measurement period.

The order for the first portion and the second portion of the measurement period may be preconfigured or dynamically indicated. Optional step 1206 includes the transmitter of the network device transmitting to the apparatus, in DCI or MAC signaling, the dynamically indicated order for the first portion and the second portion of the measurement period. In some cases, step 1206 may be performed before step 1204. Further, step 1206 may performed simultaneously with step 1204. For example, the indication to perform the configured measurement and the dynamically indicated order could be sent together in the same control signaling.

The methods 1100, 1200 may enable inter-carrier/BWP measurement at an apparatus, which could help obtain measurement information for configured carriers/BWPs at apparatus that may be later used for scheduled data transmission according to indications from a network device. In this way, the methods 1100, 1200 may help reduce scheduling latency. It should be noted that the measurement periods in the methods 110, 1200 may include one or more further portions, in addition to the first and second portions. These further portions may include measurements of further carriers/BWPs.

### CONCLUSION

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for an apparatus in a wireless communication network, the method comprising:
receiving, by the apparatus from a network device, a measurement configuration for a first carrier and/or a first bandwidth part (BWP);
measuring, by the apparatus, the first carrier and/or the first BWP based on the measurement configuration to obtain measurement information for the first carrier and/or the first BWP; and
transmitting, by the apparatus to the network device, a measurement report for a second carrier and/or a second BWP, wherein the measurement report for the second carrier and/or the second BWP is based on the measurement information for the first carrier and/or the first BWP, and wherein the first carrier and/or the first BWP and the second carrier and/or the second BWP are in a first measurement group.

2. The method of claim 1, the method further comprising:
receiving, by the apparatus from the network device, a measurement report configuration for the second carrier and/or the second BWP of the first measurement group; and
obtaining, by the apparatus, the measurement report for the second carrier and/or the second BWP based on the measurement report configuration.

3. The method of claim 2, wherein the measurement report configuration comprises at least one of the following:
a measurement event;
a condition for triggering a measurement report
a measurement report quantity;
a measurement report type; or
a time interval for measurement reporting.

4. The method of claim 1, wherein the measurement configuration comprises at least one of the following:
a measurement object;
a measurement quantity;
measurement resources comprising at least one of time resources or frequency resources;
a measurement report configuration; or
a measurement gap.

5. The method of claim 1, the method further comprising:
transmitting, by the apparatus to the network device, information regarding at least one measurement group including the first measurement group.

6. The method of claim 5, wherein the information regarding the at least one measurement group is based on at least one of an artificial intelligence (AI) capability, a sensing capability or a position of the apparatus.

7. The method of claim 5, the method further comprising:
receiving, by the apparatus from the network device, an indication of available carriers and/or available BWPs for the apparatus, wherein the information regarding the at least one measurement group is based on the available carriers and/or the available BWPs.

8. The method of claim 5, wherein the information regarding the at least one measurement group comprises an indication of at least one preferred reference carrier and/or at least one preferred reference BWP for the first measurement group.

9. The method of claim 1, the method further comprising:
receiving, by the apparatus from the network device, information regarding at least one measurement group including the first measurement group.

10. An apparatus comprising:
at least one processor; and
a computer readable storage medium operatively coupled to the at least one processor, the computer readable storage medium storing programming for execution by the at least one processor, the programming comprising instructions to:
receive, from a network device, a measurement configuration for a first carrier and/or a first bandwidth part (BWP);
measure the first carrier and/or the first BWP based on the measurement configuration to obtain measurement information for the first carrier and/or the first BWP; and
transmit, to the network device, a measurement report for a second carrier and/or a second BWP, wherein the measurement report for the second carrier and/or the second BWP is based on the measurement information for the first carrier and/or the first BWP, and wherein the first carrier and/or the first BWP and the second carrier and/or the second BWP are in a first measurement group.

11. A method for a network device in a wireless communication network, the method comprising:
transmitting, by the network device to an apparatus, a measurement configuration to obtain measurement information for a first carrier and/or a first bandwidth part (BWP),
receiving, by the network device from the apparatus, a measurement report for a second carrier and/or a second BWP, wherein the measurement report for the second carrier and/or the second BWP is based on the measurement information for the first carrier and/or the first BWP, and wherein the first carrier and/or the first BWP and the second carrier and/or the second BWP are in a first measurement group.

12. The method of claim 11, the method further comprising:
transmitting, by the network device to the apparatus, a measurement report configuration for the second carrier and/or the second BWP of the first measurement group,
wherein the measurement report for the second carrier and/or the second BWP is based on the measurement report configuration.

13. The method of claim 12, wherein the measurement report configuration comprises at least one of the following:
a measurement event;
a condition for triggering a measurement report;
a measurement report quantity;
a measurement report type; or
a time interval for measurement reporting.

14. The method of claim 11, wherein the measurement configuration comprises at least one of the following:
a measurement object;
a measurement quantity;
measurement resources comprising at least one of time resources or frequency resources;
a measurement report configuration; or
a measurement gap.

15. The method of claim 11, the method further comprising:
receiving, by the network device from the apparatus, information regarding at least one measurement group including the first measurement group.

16. The method of claim 15, the method further comprising:
transmitting, from the network device to the apparatus, an indication of available carriers and/or available BWPs for the apparatus, wherein the information regarding the at least one measurement group is based on the available carriers and/or the available BWPs.

17. The method of claim 15, wherein the information regarding the at least one measurement group comprises an indication of at least one preferred reference carrier and/or at least one preferred reference BWP for the first measurement group, wherein the first carrier and/or the first BWP is one of the at least one preferred reference carrier and/or the at least one preferred reference BWP.

18. The method of claim 11, the method further comprising:
transmitting, by the network device to the apparatus, information regarding at least one measurement group including the first measurement group.

19. The method of claim 18, wherein the information regarding the at least one measurement group is based on at least one of an artificial intelligence (AI) capability, a sensing capability or a position of the apparatus.

20. A network device comprising:
at least one processor; and
a computer readable storage medium operatively coupled to the at least one processor, the computer readable storage medium storing programming for execution by the at least one processor, the programming comprising instructions to:
transmit, to an apparatus, a measurement configuration to obtain measurement information for a first carrier and/or a first bandwidth part (BWP);
receive, from the apparatus, a measurement report for a second carrier and/or a second BWP, wherein the measurement report for the second carrier and/or the second BWP is based on the measurement information for the first carrier and/or the first BWP, and wherein the first carrier and/or the first BWP and the second carrier and/or the second BWP are in a first measurement group.
